(19) United States
(12) Patent Application Publication
(10) Pub. No.: US 2025/0197118 A1
(43) Pub. Date: Jun. 19, 2025

(54) A REMOTELY OPERATED VEHICLE FOR AN AUTOMATED STORAGE AND RETRIEVAL SYSTEM

(71) Applicant: AutoStore Technology AS, Nedre Vats (NO)

(72) Inventors: Trond Austrheim, Etne (NO); Ivar Fjeldheim, Haugesund (NO)

(21) Appl. No.: 18/846,774

(22) PCT Filed: Mar. 16, 2023
(86) PCT No.: PCT/EP2023/056690

§ 371 Date: Sep. 13, 2024

(30) Foreign Application Priority Data
Mar. 23, 2022 (NO) 20220351

(51) Int. Cl. B65G 1/137; B65G 1/04

(52) U.S. Cl. CPC B65G 1/1373; B65G 1/0464; B65G 1/0478

(57) ABSTRACT

It is disclosed a remotely operated vehicle, an automated storage and retrieval system comprising the remotely operated vehicle, and a method of using same. The remotely operated vehicle comprises: ⋅—a first set of wheels (610) configured to move the remotely operated vehicle (600) in the first direction (X) along the first set of rails (110), ⋅—a second set of wheels (620) configured to move the remotely operated vehicle (600) in the second direction (Y) along the second set of rails (111), ⋅—a wheel lift mechanism (630) configured to disengage the first set of wheels (610) from the rail system (108) to bring the second set of wheels (620) into engagement with the second set of parallel rails (111), ⋅—and configured to disengage the second set of wheels (620) from the rail system (108) to bring the first set of wheels (610) into engagement with the first set of parallel rails (110), and ⋅—a counter weight (640) coupled to the wheel lift mechanism (630) such that operation of the wheel lift mechanism (630) causes a centre of gravity (CoG) of the remotely operated vehicle (600) to change in the first direction (X) and/or in the second direction (Y) through movement of the counter weight.

### FIELD OF THE INVENTION

The present invention relates to a remotely operated vehicle for an automated storage and retrieval system for storage and retrieval of containers, in particular to a remotely operated vehicle with improved stability.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201, 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201, 301, 401 in a first direction X across the top of the framework structure 100, and a second set of parallel rails 111 arranged perpendicular to the first set of rails 110 to guide movement of the container handling vehicles 201, 301, 401 in a second direction Y which is perpendicular to the first direction X. Containers 106 stored in the columns 105 are accessed by the container handling vehicles 201, 301, 401 through access openings 112 in the rail system 108. The container handling vehicles 201, 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201, 301, 401 comprises a vehicle body 201a, 301a, 401a and first and second sets of wheels 201b, 201c, 301b, 301c, 401b, 401c which enable the lateral movement of the container handling vehicles 201, 301, 401 in the X direction and in the Y direction, respectively. In FIGS. 2, 3 and 4 two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z which is orthogonal the first direction X and the second direction Y. Parts of the gripping device of the container handling vehicles 301, 401 are shown in FIGS. 3 and 4 indicated with reference number 304, 404. The gripping device of the container handling device 201 is located within the vehicle body 201a in FIG. 2 and is thus not shown.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1. . . n and Y=1. . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110, 111 may comprise two parallel tracks. In other rail systems 108, each rail in one direction (e.g. an X direction) may comprise one track and each rail in the other, perpendicular direction (e.g. a Y direction) may comprise two tracks. Each rail 110, 111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301, 401 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301, 401 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system I may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201, 301, 401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 which typically is computerized and which typically comprises a database for keeping track of the storage containers 106.

One way of increasing the efficiency of an automated storage and retrieval system is to increase the speed of the remotely operated vehicles operating therein. With increased speed, there is a growing risk of the remotely operated vehicle tilting. To increase the stability of the remotely operated vehicle, the wheel base can be made longer. However, a longer wheel base has the downside that the robot will occupy a larger area which in turn may negatively affect traffic in the automated storage and retrieval system. Another way of improving the stability is to add weight to the remotely operated vehicle, preferably centrally arranged in a lower part thereof. However, with a higher weight, the remotely operated vehicle becomes less energy efficient and its battery will have to be charged more often.

In WO2014/090684A1 it is disclosed a remotely operated vehicle with an improved stability compared to the cantilever design of NO317366.

The stability may depend on how the remotely operated vehicle is assembled. An optimal weight distribution may not be obtainable due to the uneven size and weight of different components. The remotely operated vehicle may therefore be less stable when traveling in a first direction then when traveling in a second direction. The remotely operated vehicle may also be less stable when traveling and carrying a container then when traveling without carrying a container, of vice versa.

It is therefore an aim of the present invention to provide a remotely operated vehicle with improved stability.

### SUMMARY OF THE INVENTION

The present invention is set forth and characterized in the independent claims, while the dependent claims describe other characteristics of the invention.

The present invention relates to a remotely operated vehicle for an automated storage and retrieval system, wherein the automated storage and retrieval system comprises a rail system comprising a first set of parallel rails arranged in a horizontal plane and extending in a first direction and a second set of parallel rails arranged in the horizontal plane and extending in a second direction perpendicular to the first direction,

wherein the remotely operated vehicle comprises:
a first set of wheels configured to move the remotely operated vehicle in the first direction along the first set of rails,
a second set of wheels configured to move the remotely operated vehicle in the second direction along the second set of rails,
a wheel lift mechanism configured to disengage the first set of wheels from the rail system to bring the second set of wheels into engagement with the second set of parallel rails, and configured to disengage the second set of wheels from the rail system to bring the first set of wheels into engagement with the first set of parallel rails, and
a counter weight coupled to the wheel lift mechanism such that operation of the wheel lift mechanism causes a centre of gravity of the remotely operated vehicle to change in the first direction and/or in the second direction through movement of the counter weight.

The centre of gravity (CoG) of the remotely operated vehicle may additionally change in a third direction Z through movement of the counter weight. The third direction Z being vertical, i.e. perpendicular to both the first direction X and the second direction Y. The height of the centre of gravity may also affect the stability of the remotely operated vehicle, wherein a lower centre of gravity generally provides better stability than a higher centre of gravity. The movement of the counter weight follows a path which has a horizontal component and may have a vertical component. If the path has a vertical component, the height of the counter weight will change as it moves. By changing the height of the counter weight, the height of the centre of gravity will change according to the weight ratio between the counter weight and the remotely operated vehicle.

It is thus achieved a remotely operated vehicle which adapts its centre of gravity based on which set of wheels that are engaged with the rail system, i.e. based on the remotely operated vehicle's direction of travel.

The first set of wheels may define a first footprint and the second set of wheels may define a second footprint. The first footprint and the second footprint may be different (e.g. in shape and size) and/or they may be offset with respect to each other. The preferred positioning of the centre of gravity of the remotely operated vehicle may therefore change depending on its direction of travel.

The positioning of other components of the remotely operated vehicle such as a battery and motor will also affect the centre of gravity. Furthermore, the centre of gravity will change depending on whether the remotely operated vehicle is handling a goods holder or not. Additionally, if the remotely operated vehicle is handling a goods holder, the centre of gravity will be affected by the type of goods and its distribution in the goods holder. These factors may result in a centre of gravity that is appropriate when moving in the first direction but undesirable when moving in the second direction, and vice versa, or even undesirable for both directions of travel. The possibility of adjusting the remotely operated vehicle's centre of gravity depending on its direction of travel can therefore be advantageous.

When the remotely operated vehicle is stationary, its resultant force vector, i.e., the vector of the resultant force exerted on the rails by the remotely operated vehicle through its own weight, any load it is carrying and any acceleratory or decelerating force acting on the remotely operated vehicle and any load it is carrying, will be aligned with the vertical direction Z and directed downwards within the first or second footprint. During acceleration and deceleration of the remotely operated vehicle the direction and size of the resultant force vector may shift, typically to be angled through the combination of the weight and the acceleration/deceleration. If the resultant force vector goes outside the first or second footprint the remotely operated vehicle will tip over or tilt. The position of the centre of gravity will therefore determine the maximum acceleration/deceleration possible without the remotely operated vehicle tilting. With the possibility of adjusting the remotely operated vehicle's centre of gravity depending on its direction of travel, the remotely operated vehicle's acceleration/deceleration can be increased and thus its efficiency can also be increased.

The counter weight may be one piece or an assembly comprising several parts, for example, each part providing a component of the weight of the counter weight. The counter weight may be integrated in the wheel lift mechanism or arranged separated from the wheel lift mechanism.

The counter weight may be arranged external of the first section and the second section in space which could be considered a third section (not illustrated). Such a third section may not need to be defined by physical boundaries. The counter weight may e.g. be arranged outside a housing of the remotely operated vehicle.

The counter weight may be coupled to the wheel lift mechanism in any way making the counter weight move at least horizontally in the first direction X and/or the second direction Y relative the remotely operated vehicle in response to a vertical movement of the first set of wheels or the second set of wheels. The counter weight may be coupled to the wheel lift mechanism through being mechanically connected either directly or indirectly to the wheel lift mechanism. Mechanical connection between the counter weight and the wheel lift mechanism may be achieved by means of one or more linkages and/or one or more gears.

Alternatively, the counter weight may be coupled to the wheel lift mechanism by means of signal communication, either via cable or wirelessly.

Operation of the counter weight may be achieved by means of a different device to the wheel lift motor, e.g. if the counter weight is connected to the wheel lift mechanism by means of signal communication. Such a device may e.g. be an electric actuator or any other device suitable for creating movement of the counter weight. The wheel lift mechanism may then be operated by a motor which is not connected to the counter weight.

Alternatively, the counter weight and the wheel lift mechanism may be operated by the same motor. The counter weight may then be connected to a motor directly (i.e. without being connected to the wheel lift mechanism) or indirectly (i.e. connected to the motor via the wheel lift mechanism).

The counter weight may be configured with a delay such that the adjustment of the centre of gravity takes place shortly after or shortly before operation of the wheel lift mechanism.

One or several counter weights may be arranged in the same remotely operated vehicle. If several counter weights are arranged in the same remotely operated vehicle, these may be synchronized in movement and in orientation.

The wheel lift mechanism is typically powered by a motor and may engage and disengage a set of wheels by means of linear or pivotal motion of the wheel lift device and/or the motor.

If the wheel lift mechanism is configured to lift and lower the first set of wheels, the first set of wheels may be lowered onto the rail system such that the second set of wheels are lifted off the rail system. If the second set of wheels are not movable relative to the body of the remotely operated vehicle, the weight of the remotely operated vehicle will be lifted when lifting the second set of wheels. The counter weight may therefore at least to some extent be configured to balance the momentum of the wheel lift mechanism during this operation, such that the momentum experienced when lowering the second set of wheels is reduced. This can be advantageous for the operation of the wheel lift mechanism both during lowering and lifting of the first set of wheels, and additionally as long as the first set of wheels are engaged with the rail system. Less power may thus be required by the motor operating the wheel lift mechanism and a smoother operation of the wheel lift mechanism can be achieved.

The first set of wheels may be configured to move the remotely operated vehicle only in the first direction X along the first set of rails, e.g. by having wheels with a given axis of rotation, i.e. not caster wheels. The second set of wheels may be configured to move the remotely operated vehicle only in the second direction Y along the second set of rails, e.g. by having wheels with a given axis of rotation, i.e. not caster wheels.

The remotely operated vehicle may comprise a storage compartment or storage space for receiving and stowing a goods holder when transporting the goods holder across the rail system.

In one aspect, the first set of wheels may comprise a first pair of drive wheels and a first pair of non-driven wheels, and wherein, when the wheel lift mechanism is operated to engage the first set of wheels with the rail system, the counter weight is configured to move the centre of gravity (CoG) towards the first pair of drive wheels such that the weight of the remotely operated vehicle is distributed to the first pair of drive wheels by at least 60%, preferably at least 70%, more preferred at least 80%, and even more preferred at least 90% when the remotely operated vehicle is stationary and not handling a goods holder.

If the position of the centre of gravity is not known, the weight distributed to the first pair of drive wheels can be calculated as the weight through the first pair of drive wheels divided by the weight through the first set of wheels (multiplied by 100 to show in percent).

If the position of the centre of gravity is known, the weight distributed to the first pair of drive wheels can be calculated as the horizontal distance between the centre of gravity and the first pair of non-driven wheels divided by the horizontal distance between the first pair of driven wheels and the first pair of non-driven wheels (multiplied by 100 to show in percent).

Said preferred weight distribution will typically be achieved when the remotely operated vehicle is not handling a goods holder and is moving with a constant speed or is stationary. If the remotely operated vehicle is handling a goods holder, the weight will typically be more evenly distributed between the pair of drive wheels and the pair of non-driven wheels.

The complexity of the drive mechanism and wheel lift mechanism can be reduced through a set of wheels having a pair of non-driven wheels. This in turn may reduce the overall complexity of the remotely operated vehicle.

It is advantageous to have as much of the weight of the remotely operated vehicle as possible on the pair of drive wheels and as little weight as possible on the pair of non-driven wheels, because the traction of the remotely operated vehicle will then improve. Therefore, in terms of traction, the closer to the pair of drive wheels the centre of gravity is located the better.

During acceleration and deceleration, the resultant force vector will change such that the felt weight distribution will shift, even if the counter weight is not moved relative to the remotely operated vehicle. If the non-driven wheels are leading, acceleration will cause the weight distribution to move away from the non-driven wheels and towards the drive wheels. If the non-driven wheels are leading, deceleration will cause the weight distribution to move towards the non-driven wheels and away from the drive wheels. If the non-driven wheels are following, acceleration will cause the weight distribution to move towards the non-driven wheels and away from the drive wheels. If the non-driven wheels are following, deceleration will cause the weight distribution to move away from the non-driven wheels and towards the drive wheels. If a goods holder is carried by the remotely operated vehicle, items stored in the goods holder may slide in response to acceleration/deceleration and thus increase the shifting of the weight distribution.

The centre of gravity should preferably be located on the same side of the pair of drive wheels as the non-driven wheels in order to avoid the pair of non-driven wheels loosing contact with the rail system and to avoid the remotely operated vehicle tilting or tipping up. The weight of the remotely operated vehicle should therefore be distributed to the first pair of drive wheels by less than 100%.

The drive wheels are configured to provide propulsion and may be powered by an electric motor.

The drive wheels may comprise driving means situated at or at least partly within the wheels, e.g. as disclosed in WO2016/120075A1.

The drive wheels of each set of wheels are preferably synchronized, e.g. in a similar manner as disclosed in WO2018/082971A1.

The non-driven wheels may turn independently of one another.

In one aspect, the wheels of the first pair of drive wheels may be axially aligned with each other, and/or wherein the wheels of the first pair of non-driven wheels may be axially aligned with each other.

In one aspect, the second set of wheels may comprise a second pair of drive wheels and a second pair of non-driven wheels, and wherein, when the wheel lift mechanism may be operated to engage the second set of wheels with the rail system, the counter weight may be configured to move the centre of gravity towards the second pair of drive wheels, such that the weight of the remotely operated vehicle may be distributed to the second pair of drive wheels by at least 60%, preferably at least 70%, more preferred at least 80%, and even more preferred at least 90% when the remotely operated vehicle is stationary and not handling a goods holder.

The reference for the desired weight distribution between the drive wheels and the non-driven wheels may typically be a stationary remotely operated vehicle not handling a goods holder.

The weight of the remotely operated vehicle should therefore be distributed to the second pair of drive wheels by less than 100%.

The centre of gravity may shift in a direction affecting the weight distribution between the drive wheels and the non-driven wheels in an undesirable way when the remotely operated vehicle picks up/puts down a goods holder. This may depend on factors such as the configuration of the remotely operated vehicle, e.g. if it is a cantilever type or a cavity type, and the positioning of the drive wheels relative to the position of the carried goods holder.

The storage space may comprise a cavity arranged internally within the vehicle body, e.g. as described in WO2015/193278A1, WO2014/090684A1 and WO2019/206487A1, the contents of which are incorporated herein by reference.

As an alternative, the remotely operated vehicle may have a cantilever construction. Such a vehicle is described in detail in e.g. NO317366, the contents of which are also incorporated herein by reference.

The counter weight should preferably be configured such that picking up/putting down a goods holder does not shift the centre of gravity or the resultant force vector to a position outside the footprint defined by contact points of the set of wheels being engaged with the rail system.

The remotely operated vehicle may comprise two or more counter weights. The counter weights may be identical in shape and weight. A pair of counter weights may be provided, the counter weights being arranged on opposite sides of the remotely operated vehicle.

The weight of the counter weight(s) may constitute 5-40% of the overall weight of the remotely operated vehicle, preferably 10-35%, more preferred 15-30%, even more preferred 20-25%.

If two counter weights are used, each counter weight may weigh 10 kg. In which case the overall weight of the remotely operated vehicle may be 95 kg or less. In which case the combined weight of the remotely operated vehicle and a fully loaded goods holder may be 125 kg.

If the remotely operated vehicle comprises two counter weights, these may have the same weight. However, if an arrangement of components within the remotely operated vehicle cause an uneven weight distribution, e.g. such that more weight is distributed to one of the wheels of the first pair of driven wheels that the other, then the two counter weights may be positioned and sized to even out the weight distribution between the wheels of the first pair of driven wheels. For a first pair of drive wheels having two wheels, the weight distribution between these two wheels should preferably be 50:50.

A remotely operated vehicle comprising a counter weight coupled to its wheel lift mechanism, as described herein, may achieve an improved weight distribution between the pair of drive wheels and the non-driven wheels. The improved weight distribution may provide at least 10% more weight on the pair of drive wheels as compared to a remotely operated vehicle comprising a static counter weight or a remotely operated vehicle not comprising a counterweight.

The counter weight may be shaped to follow a contour of the remotely operated vehicle, e.g. a contour of a vehicle body.

The counter weight may be shaped to provide access to other components of the remotely operated vehicle, e.g. a hex head for manual operation of the wheel lift mechanism.

The counter weight may be shaped with a part configured to fit into a space between other components of the remotely operated vehicle, e.g. a protruding part fitting between a lifting frame and a vehicle body in one position of the counter weight.

Achieving the desired weight distribution between the drive wheels and the non-driven wheels when the remotely operated vehicle is carrying a goods holder may in some cases require a heavier counter weight as compared to achieving the desired weight distribution between the drive wheels and the non-driven wheels when the remotely operated vehicle is not carrying a goods holder. In such cases, the benefits of the desired centre of gravity should be measured against the benefits of a lighter remotely operated vehicle.

If the remotely operated vehicle comprises a lifting device for lifting a goods holder, the remotely operated vehicle may comprise an additional counter weight. The additional counter weight may be coupled to the lifting device e.g. such that operation of the lifting device causes the centre of gravity of the remotely operated vehicle to change in the first direction X and/or in the second direction Y through movement of the additional counter weight. Operation of the lifting device will typically involve picking up/putting down a goods holder.

If the remotely operated vehicle comprises a lifting device for lifting a goods holder, the counter weight may be moved a given amount in order to take account of the effect on the resultant force vector from the movement of the lifting device. The movement of the counter weight may also be determined based on a measured or known weight of the lifted goods holder and its content, if any. E.g. the counter weight may move a smaller angular amount about the pivot for smaller loads and more for heavier loads, to counter balance the effect of a heavy load versus a light load.

In one aspect, the wheels of the second pair of drive wheels may be aligned in a common vertical plane, and/or wherein the wheels of the second pair of non-driven wheels may be aligned in a common vertical plane. The wheels of the second pair of drive wheels may be aligned in a different vertical plane than the wheels of the second pair of non-driven wheels.

In one aspect, the remotely operated vehicle may comprise: a vehicle body, a first linkage linked to the counter weight at a first end and pivotally connected to the vehicle body at a second end, and a second linkage connected to the wheel lift mechanism at a first end and pivotally connected to a middle portion of the first linkage at a second end, such that operation of the wheel lift mechanism causes the first linkage to pivot.

The first linkage may allow the counter weight to move in a rotating manner around its pivotal connection to the vehicle body. The counter weight may thus primarily move with both a horizontal component (in the first direction X and or the second direction Y) and a vertical component (in the third direction Z).

The first linkage may be linked to the counter weight through being connected. Alternatively, the first linkage may be an integral part of the counter weight.

During operation, the wheel lift mechanism will move back and forth depending on which set of wheels (the first set of wheels or the second set of wheels) is to be engaged with the rail system. Movement of the wheel lift mechanism will cause the connected second linkage to pull or push on the first linkage causing it to rotate and thus move the counter weight.

The length of the first linkage may affect the travel of the counter weight in response to operation of the wheel lift mechanism. By increasing the length of the first linkage, the horizontal adjustment of the centre of gravity may also be increased. As a result, the weight of the counter weight may be reduced such that the overall weight of the remotely operated vehicle is consequently also reduced.

If the first section and the second section are at least partly physically divided, the dividing component(s) may serve as a mounting base for the pivots of the counter weight. The horizontal distance between the dividing component(s) and the exterior of the remotely operated vehicle may dictate the maximum length of the first linkage, unless the counter weight is arranged external to the remotely operated vehicle. With a given maximum length of the linkage, the required minimum weight of the counter weight may be determined.

In one aspect, the counter weight may have an initial position in which it is vertically aligned with the pivotally connection at the second end of the first linkage. In this context vertically aligned also encompass slightly off vertical, such as within 10 degrees of vertical.

Movement from this initial position will provide the greatest immediate horizontal change of the counter weight's position in response to a rotation of the first linkage, hence also the greatest immediate horizontal change of the remotely operated vehicle's centre of gravity.

In an alternative initial position, the first linkage may be oriented 45° relative to a vertical plane. Operation of the wheel lift mechanism should then preferably rotate the first linkage towards an alignment with the horizontal plane, and possibly beyond an alignment with the horizontal plane, e.g. if the first linkage has an angular displacement greater than 90°.

The counter weight is typically in the initial position after the wheel lift mechanism has been operated to disengage the first set of wheels and engage the second set of wheels, or vice versa.

In one aspect, operation of the wheel lift mechanism may cause an angular displacement of the first linkage of at least 15°, preferably at least 30°, and more preferred at least 45°.

The angular displacement of the first linkage may be at least 90°.

The maximum rotation of the first linkage may be 180°.

In one aspect, the remotely operated vehicle may be configured to handle a goods holder.

The goods holder may e.g. be a storage container, a bin, a tote, a pallet, a tray or similar. Different types of goods holders may be used in the same system. The weight of the goods holder may typically be in the range of 5-35 kg, depending on its content.

In one aspect, the remotely operated vehicle may comprise a goods holder storage space.

The goods holder storage space will typically be arranged in vertical alignment within the footprint of the first set of wheels and the footprint of the second set of wheels.

The remotely operated vehicle may comprise a lifting device for vertical transportation of goods holders, e.g. raising a goods holder from, and lowering a goods holder into, a storage column.

The lifting device typically comprises: lifting bands, a gripper, guide pins, a lifting frame, and a lifting device motor. Wherein the lifting bands are connected to the lifting frame such that winding in/out the lifting bands cause the lifting frame to be raised/lowered. This winding may be effected by the lifting device motor. To align the lifting frame with a goods holder, it may be provided with one or more (typically four) guide pin(s). The goods holders may have a corresponding number of receptacles arranged for receiving the guide pins in a guiding manner. The lifting frame may be provided with one or more gripper(s) for latching onto a goods holder such that the goods holder can be raised/lowered together with the lifting frame.

The lifting device may be configured to lift a goods holder vertically between a storage position and the goods holder storage space.

The lifting device may comprise one or more gripper(s)/engaging devices which are adapted to engage a goods holder, and which gripper(s)/engaging devices can be lowered from the remotely operated vehicle so that the position of the gripper(s)/engaging devices with respect to the remotely operated vehicle can be adjusted in a third direction Z which is orthogonal the first direction X and the second direction Y.

The gripper(s) of the remotely operated vehicle may be located within the vehicle body.

In one aspect, the remotely operated vehicle may comprise a first section and a second section adjacent the first section, wherein the goods holder storage space may be arranged in the first section.

If the remotely operated vehicle comprises a lifting device, the gripper(s) will typically be arranged in the first section and a lifting device motor in the second section.

The remotely operated vehicle may comprise a stop for stopping the movement of the lifting device. The stop may be arranged to define the uppermost point of the movement of the lifting device, i.e. a top position of the lifting frame.

The stop may typically be arranged on the body of the remotely operated vehicle, e.g. in the goods holder storage space, such that the lifting frame will come to a halt as it encounters the stop. Alternatively, the stop may be arranged on the lifting frame such that the lifting frame will come to a halt as the stop encounters a part of the body of the remotely operated vehicle, typically in the goods holder storage space.

The stop may comprise a sensor. The sensor may be configured to detect the presence of an object, e.g. the presence of the lifting frame at a predetermined top position of its travel. The sensor may e.g. be a touch sensor. The sensor may communicate with the lifting device motor directly or via a control system, such that raising of the lifting frame can be stopped at an appropriate time.

The remotely operated vehicle may comprise more than one stop, e.g. four stops. The stops may be arranged to engage different parts of the lifting frame, e.g. respective corners of the lifting frame.

The height of the stop, i.e. the distance it extends in the vertical direction Z when arranged on the remotely operated vehicle, may be selected to determine the top position of the lifting frame. The height of the stop may be selected depending on the size (height) of the goods holder. The goods holder should be lifted above the rail system in order for the remotely operated vehicle to move; however, the goods holder should preferably not be lifted higher than necessary in order to keep the centre of gravity as low as possible. A lower centre of gravity will result in a more stable remotely operated vehicle as compared to a higher centre of gravity.

If the remotely operated vehicle can handle goods holders of different heights, interchangeable stops of different heights may be provided, wherein the different stops heights are adapted to the different goods holder heights to provide the lowest centre of gravity which allows the remotely operated vehicle to move while carrying the goods holder.

As an example, a first type of stop may have a first stop height, a first type of goods holder may have a first goods holder height, a second type of stop may have a second stop height, and a second type of goods holder may have a second goods holder height. The combined height of the first stop and the first goods holder may then preferably correspond to the combined height of the second stop and the second goods holder. A third type of stop having a third stop height and a third goods holder having a third goods holder height may then preferably have a combined height corresponding to the combined height of the first stop and the first goods holder.

It can thus be achieved a remotely operated vehicle configured to carry goods holders of different sizes, i.e. heights, with improved stability.

The first section and the second section may be configured in a similar manner as disclosed in WO2019/206488A1.

The first section may have a first section footprint and the second section may have a second section footprint, these footprints being defined by horizontal peripheries in the X and Y directions of the first and second sections, respectively.

The remotely operated vehicle may have a vehicle body. The vehicle body may have a vehicle body footprint defined by horizontal peripheries in the X and Y directions of the vehicle body.

The first section and the second section may be arranged side-by-side.

A centre point of the first section footprint may be arranged off centre relative a centre point of the vehicle body footprint.

The first section and the second section may together constitute the entire remotely operated vehicle. Alternatively, the remotely operated vehicle may comprise further sections in addition to the first and second sections.

The remotely operated vehicle may be divided into the first section and the second section by a vertical plane extending through the remotely operated vehicle, e.g. in the second direction Y. The vertical plate dividing the first section and the second section may have one or more kinks. With a kink, components may be arranged in a more space efficient manner.

The first section and the second section does not need to be physically separated, however there may be at least a partial boundary between them.

The first section and the second section may be of different sizes. Their sizes may e.g. be set by one or more components of the remotely operated vehicle. As an example, the first section footprint may correspond to the size of a goods holder storage space. As another example, the second section footprint may correspond to the size of a compartment configured to accommodate components of the remotely operated vehicle.

A size ratio of the first section footprint relative the second section footprint may be at least 2:1. Preferably, the size ratio of the first section footprint relative the second section footprint may be 3:1, even more preferably the size ratio of the first section footprint relative the second section footprint may be 4:1.

The combined horizontal extent of the first section footprint and the second section footprint in the first direction X may correspond to the horizontal extent of the vehicle body in the first direction X.

The second section footprint and the vehicle body footprint may have corresponding horizontal extents in the second direction Y.

The first set of wheels may comprise four wheels. The wheels of the first set of wheels may be arranged on opposite sides of the remotely operated vehicle.

The first pair of non-driven wheels may be arranged on opposite sides of the first section.

The wheels of the first pair of drive wheels may be arranged on opposite sides of the second section. Preferably none of said sides are the side of the second section being closest to the first section. E.g. if the second section has four sides, with a second side marking a transition from the second section to the first section and a fourth side representing a side opposite the second side and remote from the first section, the wheels of the first pair of drive wheels may be arranged on a first side and a third side. The wheels of the second pair of drive wheels may be arranged next to the second side; for example, the second pair of drive wheels may be arranged on a support which is configured to recess the second pair of drive wheels into a region of the second section while facing into the first section.

The second set of wheels may comprise four wheels. The wheels of the second set of wheels may be arranged on opposite sides of the first section.

The wheels of the second pair of non-driven wheels may be arranged on the same side of the first section.

The wheels of the second pair of drive wheels may be arranged on the same side of the first section.

The wheels of the second pair of drive wheels may be arranged on the side of the first section being closest to the second section.

The wheels of the second pair of non-driven wheels and the wheels of the second pair of drive wheels may be arranged on opposite sides of the first section.

The wheels of the first set of wheels and the wheels of the second set of wheels are preferably not arranged on the same side of the first section. E.g. if the first section has four sides, the first set of wheels may be arranged on a first side and a third side, while the second set of wheels may be arranged on a second side and a fourth side.

The first section may have four corners. At least some of the wheels may then preferably be arranged in the corners without extending beyond the first section footprint.

The second section may have four corners. At least some of the wheels may then preferably be arranged in the corners without extending beyond the second section footprint.

The first set of wheels and/or the second set of wheels may be arranged at or within a lateral extent of the vehicle body.

The footprint of the first section may correspond to a grid cell of the rail system, and, during use, when the remotely operated vehicle is in a position to lift or lower a goods holder, the second section may be horizontally displaced relative the grid cell and extend partly into a neighbouring grid cell.

A grid cell is defined as the cross-sectional area, including width of the rails, between the midpoint of two rails running in the X direction and the midpoint of two rails running in the Y direction.

An extent of the vehicle body footprint in the first direction, LX, and in the second direction, LY, may be:
LX=1.0 grid cell in the X direction, and
1<LY<1.5 grid cells in the Y direction.

The second section may extend less than 50% into the neighbouring grid opening, more preferably less than 40% into the neighbouring grid opening, even more preferably less than 30% into the neighbouring grid opening.

A grid opening may be defined as the open cross-sectional area between two opposed rails running in the X direction and two opposed rails running in the Y direction.

The first pair of non-driven wheels 612, the second pair for non-driven wheels 622 and the second pair of drive wheels 621 may be arranged to define a rectangle in a horizontal plane, wherein the first pair of drive wheels 611 are arranged outside said rectangle.

In one aspect, the counter weight may be arranged to be moved from a position within the second section to a position at least partly within the first section.

The counter weight may be a slave to the wheel lift mechanism, e.g. if mechanically connected thereto. However, the counter weight may also be powered by its own motor. In which case the motor powering the counter weight may preferably be arranged in the second section.

In one aspect, the wheel lift mechanism may be partly arranged in the second section.

The wheel lift mechanism may be partly arranged in the first section. Preferably the wheel lift mechanism is configured such that its main weight is arranged within the second section.

Any motors associated with the wheel lift mechanism are preferably arranged in the second section.

In one aspect, the first set of drive wheels may be arranged in the second section.

The remotely operated vehicle may comprise a motor for driving the first set of wheels and a further motor for driving the second set of wheels. These or any other motors associated with the first set of drive wheels and/or the second set of drive wheels may preferably be arranged in the second section.

Alternatively, the motors may be hub motors arranged in each wheel of the first pair of drive wheels and/or the second set of drive wheels.

In one aspect, the first set of non-driven wheels and/or the second set of non-driven wheels and/or the second set of drive wheels may be arranged in the first section.

Viewed from another aspect, the present invention can also be seen as relating to a remotely operated vehicle for an automated storage and retrieval system, wherein the automated storage and retrieval system comprises a rail system comprising a first set of parallel rails arranged in a horizontal plane and extending in a first direction and a second set of parallel rails arranged in the horizontal plane and extending in a second direction perpendicular to the first direction,

wherein the remotely operated vehicle comprises:
a first set of wheels configured to move the remotely operated vehicle in the first direction along the first set of rails,
a second set of wheels configured to move the remotely operated vehicle in the second direction along the second set of rails,
a wheel lift mechanism configured to disengage the first set of wheels from the rail system to bring the second set of wheels into engagement with the second set of parallel rails, and configured to disengage the second set of wheels from the rail system to bring the first set of wheels into engagement with the first set of parallel rails,
a cavity for receiving and stowing a goods holder when transporting the goods holder across the rail system,
a lifting device configured to lift a goods holder vertically between a storage position and the cavity, and
a stop for stopping the movement of the lifting device at a predetermined position in the cavity.

The remotely operated vehicle may comprise any one of the above-mentioned features.

Viewed from a further aspect, the present invention can also be seen to relate to an automated storage and retrieval system, wherein the automated storage and retrieval system comprises:
at least one remotely operated vehicle as described herein,
a framework structure for storing goods holders, the framework structure including a rail system, on which the remotely operated vehicle can move, arranged on top of the framework structure and comprising a first set of parallel rails arranged in a horizontal plane and extending in a first direction and a second set of parallel rails arranged in the horizontal plane and extending in a second direction perpendicular to the first direction, and
a plurality of goods holders.

The first set of parallel rails and the second set of parallel rails form a grid pattern in the horizontal plane. The grid pattern may comprise a plurality of adjacent grid cells, each grid cell comprising a grid opening defined by a pair of opposed rails of the first set of parallel rails and a pair of opposed rails of the second set of parallel rails. Each grid cell may include a width of half a rail, corresponding to a width of a track, around each grid opening, depending on the rail and track configuration.

The goods holders may be arranged in stacks below the rail system. The plurality of stacks of goods holders may be arranged in storage columns located beneath the rail system, wherein each storage column preferably is located vertically below a grid opening.

The automated storage and retrieval system may typically be a cube storage system. Except from the inventive remotely operated vehicle, the automated storage and retrieval system may be similar to the type disclosed in the prior art.

As indicated above, the remotely operated vehicle has a first section and a second section. The footprint of the first section can be equal to the size of an underlying grid cell, and the second section may be a protruding section which extends horizontally beyond the footprint of the first section.

The footprint of the second section may be less than half the size the footprint of the first section (size ratio less than 1:2 relative the first section). When the remotely operated vehicle is positioned above a grid cell in a position where it can lift or lower a storage container into or out of the first section, the second section may extend into a neighbouring grid cell. However, the footprint of the vehicle body may be less than 1.5 cells in one direction (in the X-direction) and a maximum of one grid cell wide in the other direction (Y-direction). In other words, the lateral extent of the remotely operated vehicle in the first direction corresponds to the lateral extent of the rails in one cell, and a maximum of 1.5 grid cells in the direction perpendicular to the first direction. Consequently, in an example system for storing and retrieving storage containers, where two of the remotely operated vehicles described above are operated and are oriented in opposite directions, they occupy only up to three grid cells when travelling in the first direction e.g. in the Y-direction, whereas when travelling in the second direction e.g. in the X-direction, they can travel along neighbouring rows of grid cells occupying two grid cells.

The framework structure may comprise upright members and a storage volume comprising storage columns arranged in rows between the upright members. In these storage columns goods holders can be stacked one on top of one another to form stacks. The upright members may typically be made of metal, e.g. extruded aluminum profiles.

When travelling on the rail system arranged across the top of the framework structure, the remotely operated vehicles may be operated to raise goods holders from, and lower goods holders into, the storage columns, and also to transport the goods holders above the storage columns.

Goods holders stored in the columns are accessed by the remotely operated vehicles through access openings in the rail system. The remotely operated vehicles can move laterally above the storage columns, i.e. in a plane which is parallel to the horizontal X-Y plane.

The upright members of the framework structure may be used to guide the goods holders during raising of the goods holders out from and lowering of the goods holders into the columns. The stacks of goods holders are typically self-supporting.

The rail system typically comprises rails with grooves in which the wheels of the remotely operated vehicles run. Alternatively, the rails may comprise upwardly protruding elements, where the wheels of the remotely operated vehicles comprise flanges to prevent derailing. These grooves and upwardly protruding elements are collectively known as tracks. Each rail may comprise one track, or each rail may comprise two parallel tracks. In other rail systems, each rail in one direction (e.g. an X direction) may comprise one track and each rail in the other, perpendicular direction (e.g. a Y direction) may comprise two tracks. Each rail may also comprise two track members that are fastened together, each track member providing one of a pair of tracks provided by each rail.

WO2018/146304A1, the contents of which are incorporated herein by reference, illustrates a typical configuration of rail system comprising rails and parallel tracks in both X and Y directions.

In the framework structure, a majority of the columns are storage columns, i.e. columns where goods holders are stored in stacks. However, some columns may have other purposes. An example of such special-purpose may be columns used by the remotely operated vehicle to drop off and/or pick up goods holders so that they can be transported to an access station where the goods holders can be accessed from outside of the framework structure or transferred out of or into the framework structure. Such a location can be referred to as a port and the column in which the port is located can be referred to as a port column.

The automated storage and retrieval system may comprise a port and/or a port column.

If the automated storage and retrieval system comprises a plurality of port columns, a first port column may be a drop-off port column where the remotely operated vehicle can drop off goods holders to be transported to an access or a transfer station, and a second port column may be a pick-up port column where the remotely operated vehicles can pick up goods holders that have been transported from an access or a transfer station.

The port may typically be a picking or a stocking station where product items are removed from or positioned into the goods holders. In a picking or a stocking station, the goods holders are normally not removed from the automated storage and retrieval system, but are returned into the framework structure again once accessed.

A port may also be used for transferring goods holders to another storage facility (e.g. to another framework structure or to another automated storage and retrieval system), to a transport vehicle (e.g. a train or a lorry), or to a production facility.

The automated storage and retrieval system may comprise a conveyor system comprising conveyors. The conveyor system may be employed to transport the storage containers between the port columns and the port (access station). If the port columns and the port are located at different levels, the conveyor system may comprise a lift device with a vertical component for transporting the goods holders vertically between the port column and the port.

The conveyor system may be arranged to transfer goods holders between different framework structures, e.g. as is described in WO2014/075937A1, the contents of which are incorporated herein by reference.

For monitoring and controlling the automated storage and retrieval system, e.g. monitoring and controlling the location of respective goods holders within the framework structure, the content of each goods holder, and the movement of the remotely operated vehicles so that a desired goods holder can be delivered to the desired location at the desired time without the remotely operated vehicles colliding with each other, the automated storage and retrieval system may comprise a control system which typically is computerized and which typically comprises a database for keeping track of the goods holders.

Viewed from yet a further aspect, the present invention can also be seen to relate to a method for operating an automated storage and retrieval system as described herein,

wherein the method comprises the steps of:
operating the wheel lift mechanism to engage the first set of wheels with the rail system,
moving the counter weight to adjust a centre of gravity for movement of the remotely operated vehicle in the first direction,
moving the remotely operated vehicle a predetermined distance in the first direction,
operating the wheel lift mechanism of the remotely operated vehicle to disengage the first set of wheels from the rail system and to engage the second set of wheels with the rail system,
moving the counter weight to adjust a centre of gravity for movement of the remotely operated vehicle in the second direction, and
moving the remotely operated vehicle a predetermined distance in the second direction.

A mechanism supporting the counter weight will typically be configured to operate in response to an operation of the wheel lift mechanism by means of a mechanical connection or signal communication. In this way the counter weight can be moved with respect to a remainder of the remotely operated vehicle to cause a centre of gravity of the remotely operated vehicle to change in a direction which is beneficial to the movement of the remotely operated vehicle.

When a goods holder stored in one of the columns is to be accessed, one of the remotely operated vehicles is instructed to retrieve the target goods holder from its position and transport it to the drop-off port column. This operation involves moving the remotely operated vehicle to a location above the storage column in which the target goods holder is positioned, retrieving the goods holder from the storage column using the remotely operated vehicle's lifting device, and transporting the goods holder to the drop-off port column. If the target goods holder is located deep within a stack, i.e. with one or a plurality of other goods holders positioned above the target goods holder, the operation also involves temporarily moving the above-positioned goods holders prior to lifting the target goods holder from the storage column. This step, which can be referred to as “digging”, may be performed with the same remotely operated vehicle that is subsequently used for transporting the target goods holder to the drop-off port column, or with one or a plurality of other cooperating remotely operated vehicles.

Alternatively, or in addition, the automated storage and retrieval system may comprise remotely operated vehicles specifically dedicated to the task of temporarily removing goods holders from a storage column. Once the target goods holder has been removed from the storage column, the temporarily removed goods holder can be repositioned into the original storage column. However, the removed goods holders may alternatively be relocated to other storage columns.

When a goods holder is to be stored in one of the columns, one of the remotely operated vehicles is instructed to pick up the goods holders from the pick-up port column and transport it to a location above the storage column where it is to be stored. After any goods holders positioned at or above the target position within the stack have been removed, the remotely operated vehicle positions the goods holder at the desired position. The removed goods holder may then be lowered back into the storage column, or relocated to other storage columns.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a remotely operated vehicle comprising a first set of wheels and a second set of wheels configured to move the remotely operated vehicle in a first direction X and a second direction Y respectively within an automated storage and retrieval system.

FIG. 6 is a perspective view of the remotely operated vehicle of FIG. 5 wherein some components are removed for clarity, the remotely operated vehicle comprising a counter weight configured to change a centre of gravity (CoG) of the remotely operated vehicle, and a wheel lift mechanism configured to raise and lower the first set of wheels such that the first set of wheels and the second set of wheels can be engaged and disengaged with a drive surface in the automated storage and retrieval system.

FIG. 7 is another perspective view of the remotely operated vehicle of FIG. 5 wherein some components are removed for clarity, the remotely operated vehicle comprising a goods holder storage space and a goods holder lifting device configured to lift goods holders into the goods holder storage space.

FIG. 8 is a side view of the remotely operated vehicle of FIG. 5 wherein some components are removed for clarity, wherein the remotely operated vehicle is set to move in the second direction Y and its centre of gravity has been shifted accordingly.

FIG. 9 is the same side view of the remotely operated vehicle as FIG. 8, wherein the wheel lift and the counter weight is being operated to change the remotely operated vehicle's direction of movement.

FIG. 10 is the same side view of the remotely operated vehicle as FIG. 8, wherein the remotely operated vehicle is set to move in the first direction X and its centre of gravity has been shifted accordingly.

FIG. 11 is a perspective view of details of the remotely operated vehicle of FIG. 5, showing an example of how the wheel lift mechanism and the counter weight can be coupled, such that operation of the wheel lift mechanism causes the centre of gravity (CoG) of the remotely operated vehicle to change in the first direction X through movement of the counter weight.

FIG. 12 is a perspective view of details of the remotely operated vehicle of FIG. 5, showing an example of a wheel lift mechanism being connectable to a frame of the remotely operated vehicle and configured to raise and lower the first set of wheels.

FIG. 13 is a perspective view of the remotely operated vehicle of FIG. 5 wherein some components are removed for clarity and the wheel lift mechanism has raised the first set of wheels.

FIG. 14 is a perspective view of the remotely operated vehicle of FIG. 5 wherein some components are removed for clarity and the wheel lift mechanism has lowered the first set of wheels.

FIG. 15a and FIG. 15b are schematic side views of the remotely operated vehicle wherein a counter weight is operated by an actuator when the wheel lift mechanism is operated.

FIG. 16a and FIG. 16b are schematic side views of the remotely operated vehicle wherein a counter weight is operated by an actuator when the lifting device is latching/unlatching a goods holder.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

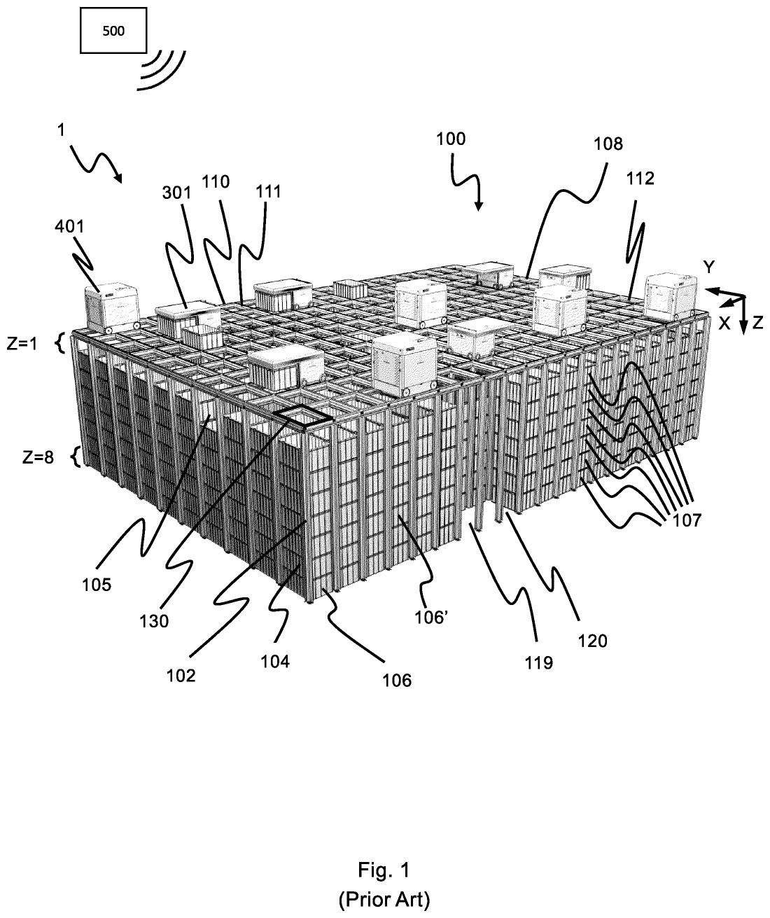

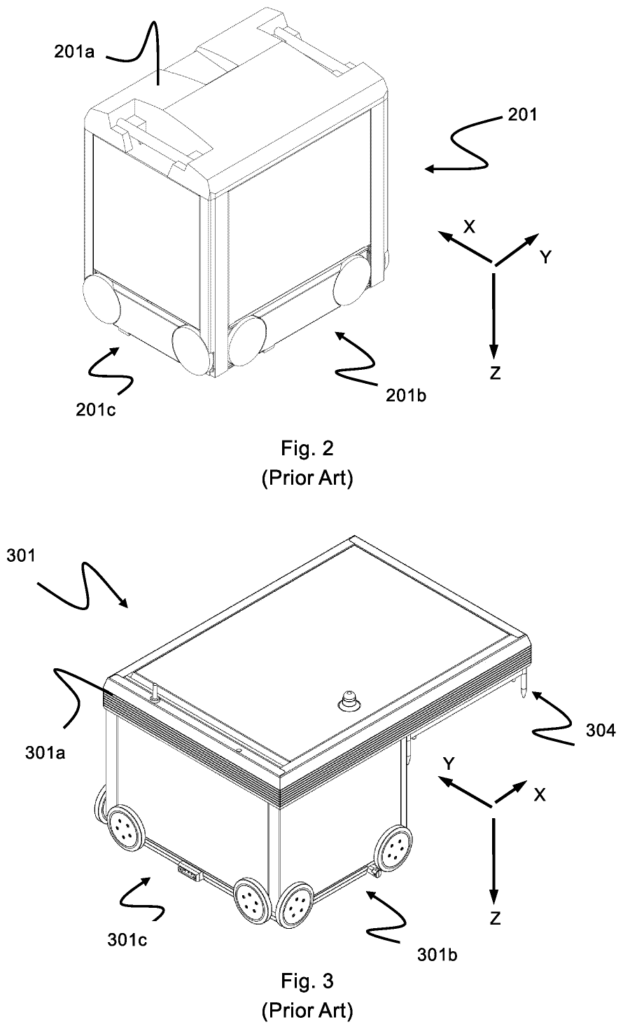

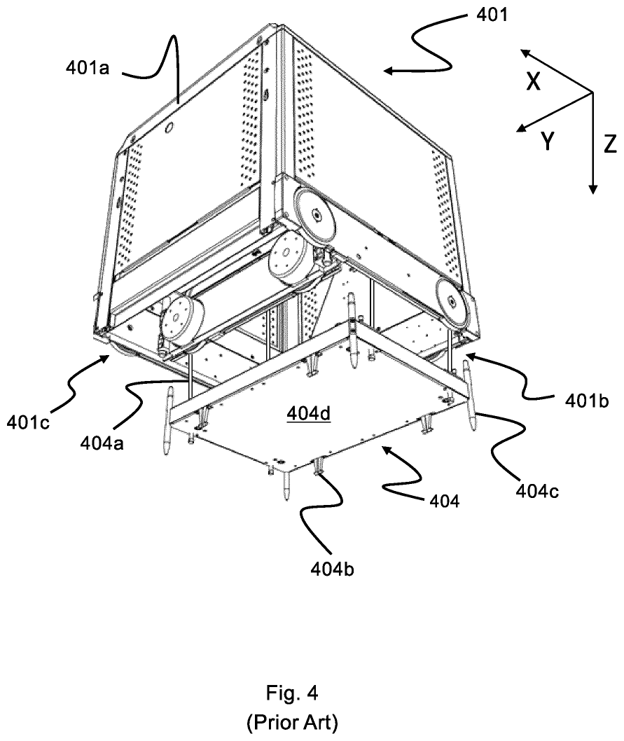

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

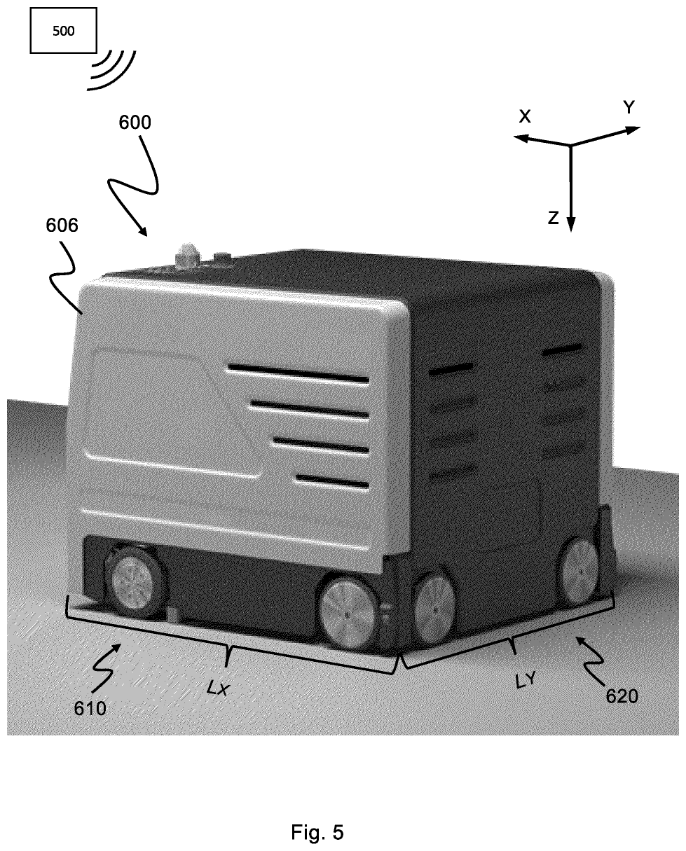

Embodiments of the automated storage and retrieval system according to the invention will now be discussed in more detail with reference to FIGS. 5-16.

FIG. 5 shows a perspective view of a remotely operated vehicle 600 being suitable for operation in an automated storage and retrieval system 1. The automated storage and retrieval system 1 may typically be a prior art automated storage and retrieval system 1 as disclosed in FIG. 1.

Such automated storage and retrieval systems 1 typically comprise a framework structure 100. The framework structure 100 may comprise upright members 102 and a storage volume comprising storage columns 105 arranged in rows between the upright members 102. In these storage columns 105 goods holders, such as storage containers 106, also known as bins, can be stacked one on top of one another to form stacks 107. The upright members 102 may typically be made of metal, e.g. extruded aluminum profiles.

The automated storage and retrieval system 1 typically comprises a rail system 108 arranged across the top of the framework structure 100, on which rail system 108 a plurality of remotely operated vehicles 201, 301, 401, 600 may be operated to raise goods holders from, and lower goods holders into, the storage columns 105, and also to transport the goods holders above the storage columns 105. The rail system 108 comprises a first set of parallel rails 110 arranged to guide movement of the remotely operated vehicles 201, 301, 401, 600 in a first direction X across the top of the framework structure 100, and a second set of parallel rails 111 arranged perpendicular to the first set of rails 110 to guide movement of the remotely operated vehicles 201, 301, 401, 600 in a second direction Y which is perpendicular to the first direction X. Goods holders stored in the columns 105 are accessed by the remotely operated vehicles 201, 301, 401, 600 through access openings 112 in the rail system 108. The remotely operated vehicles 201, 301, 401, 600 can move laterally above the storage columns 105, i.e. in a plane which is parallel to the horizontal X-Y plane.

The upright members 102 of the framework structure 100 may be used to guide the goods holders during raising of the goods holders out from and lowering of the goods holders into the columns 105. The stacks 107 of goods holders are typically self-supporting.

The remotely operated vehicle 600 comprises a first set of wheels 610 and a second set of wheels 620. In FIG. 5, only two wheels of the first set of wheels 610 are visible; however, the first set of wheels 610 will typically comprise four wheels. Similarly, only two wheels of the second set of wheels 620 are visible in FIG. 5; however, the second set of wheels 620 will typically comprise four wheels.

The first set of wheels 610 are configured to move the remotely operated vehicle 600 in the first direction X along two adjacent rails of the first set of rails 110, and the second set of wheels 620 are configured to move the remotely operated vehicle 600 in the second direction Y along two adjacent rails of the second set of rails 111.

The remotely operated vehicle 600 comprises a vehicle body. An extent of the vehicle body in the first direction, LX, and in the second direction, LY, defines a vehicle body footprint.

The remotely operated vehicle 600 may comprise cover plates 606 protecting components arranged behind them.

The remotely operated vehicle 600 may be configured to communicate with a control system 500. Which control system 500 may be configured to control the operation of one or more remotely operated vehicles 201, 301, 401, 600 in the automated storage and retrieval system 1.

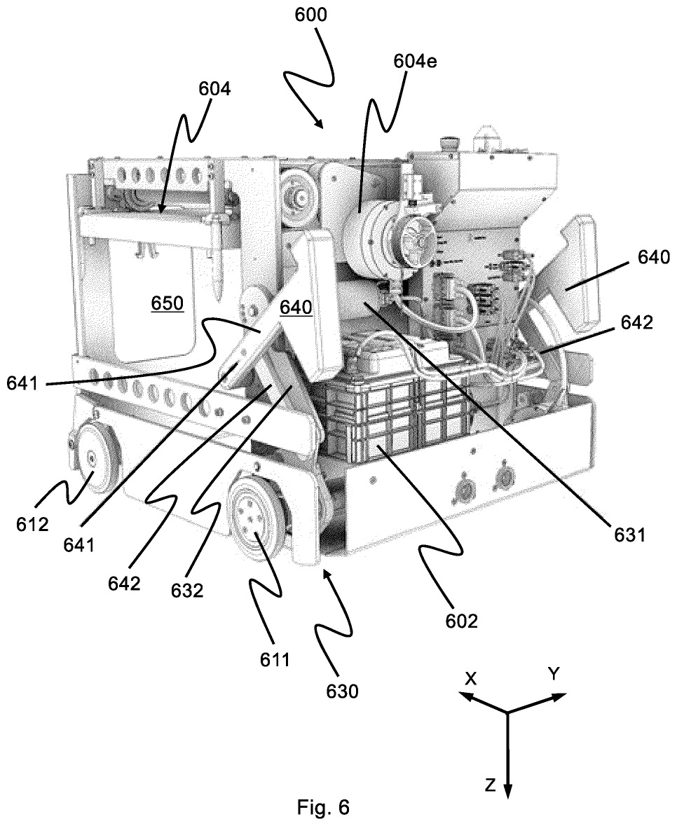

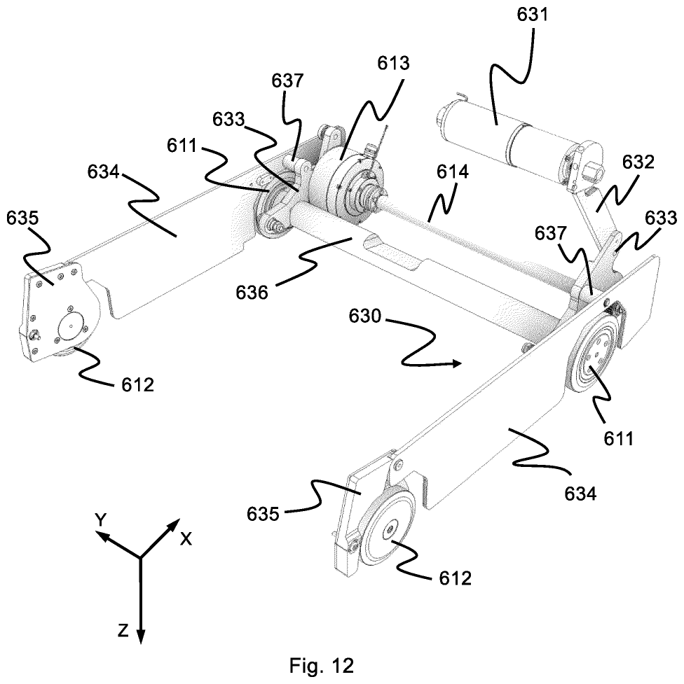

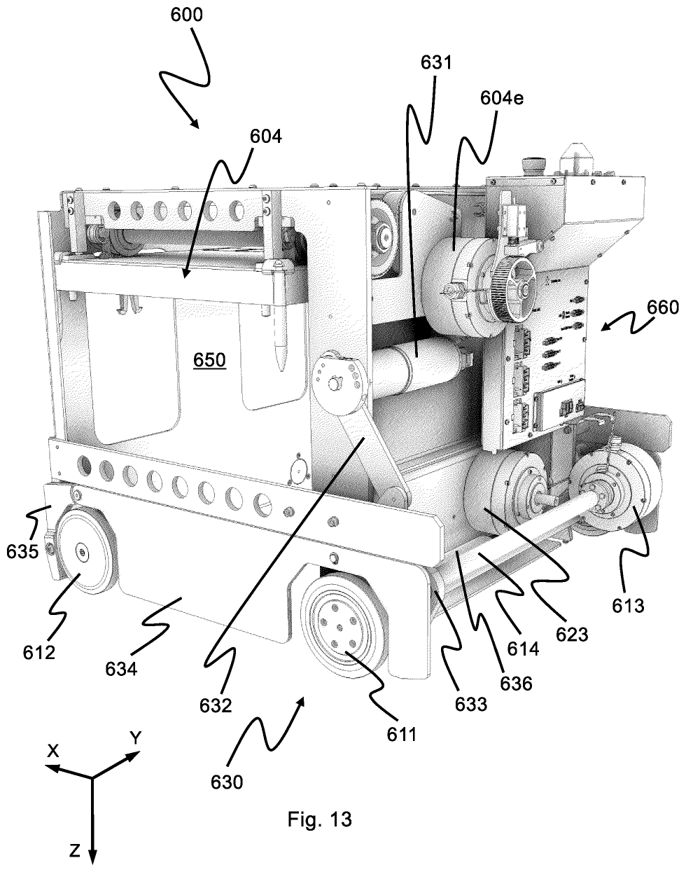

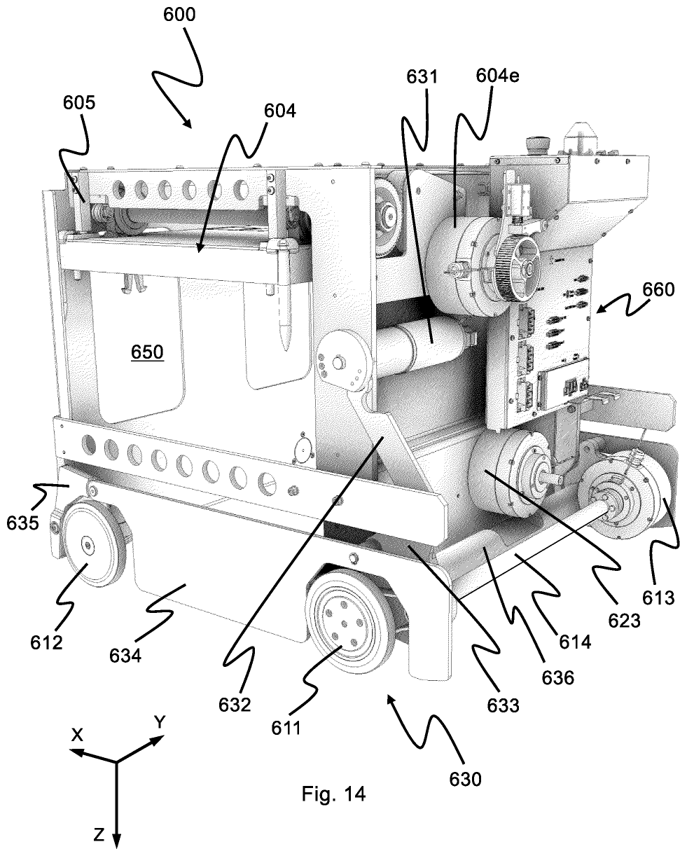

FIG. 6 shows a perspective view of the remotely operated vehicle 600 shown in FIG. 5, wherein some components have been removed. The remotely operated vehicle 600 comprises a wheel lift mechanism 630. The wheel lift mechanism 630 is configured to lift and lower the first set of wheels 610, so that the first set of wheels 610 and/or the second set of wheels 620 can be engaged with the respective set of rails 110, 111 at any one time. Details of the wheel lift mechanism 630 are shown in FIG. 12, whereas FIG. 13 and FIG. 14 illustrate operation of the wheel lift mechanism 630.

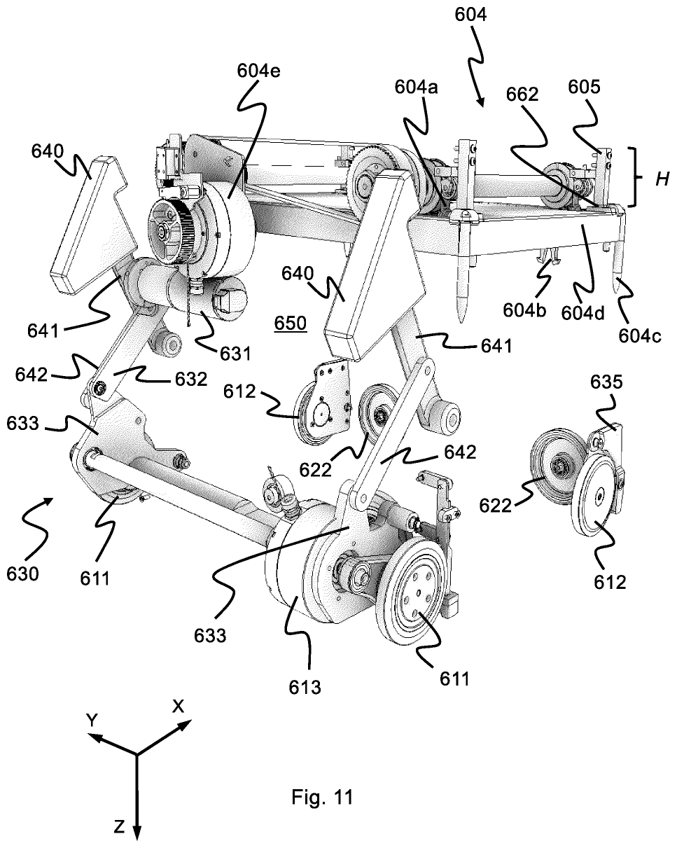

The remotely operated vehicle 600 may comprise a goods holder storage space 650 and a lifting device 604. The lifting device 604 being configured to lift a goods holder from a storage column 105 and into the goods holder storage space 650. Details of the lifting device 604 are shown in FIG. 11.

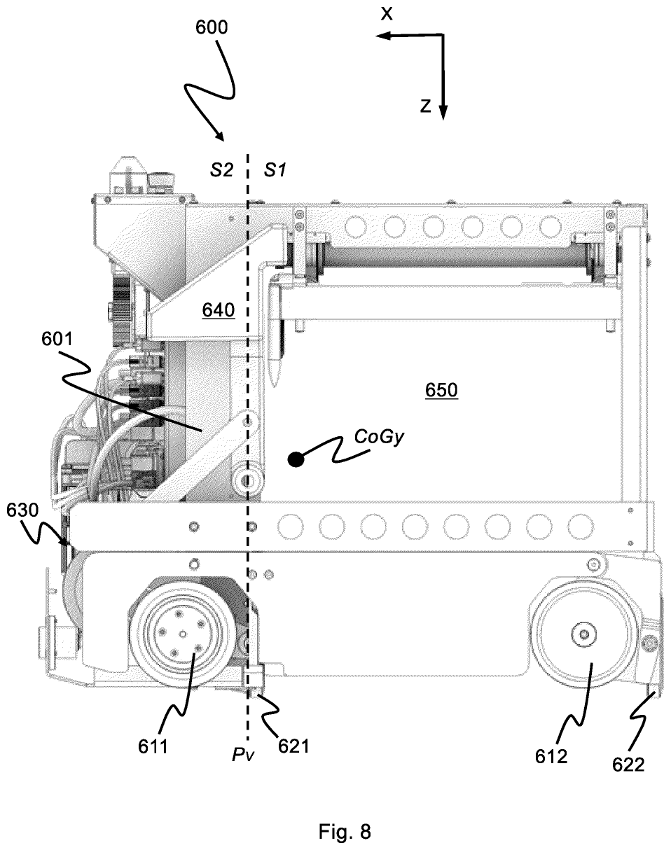

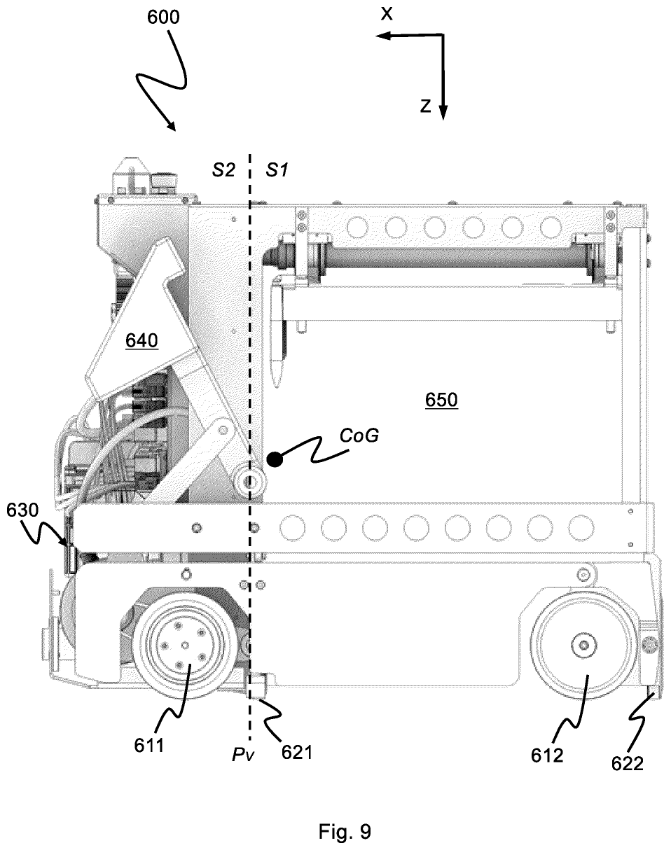

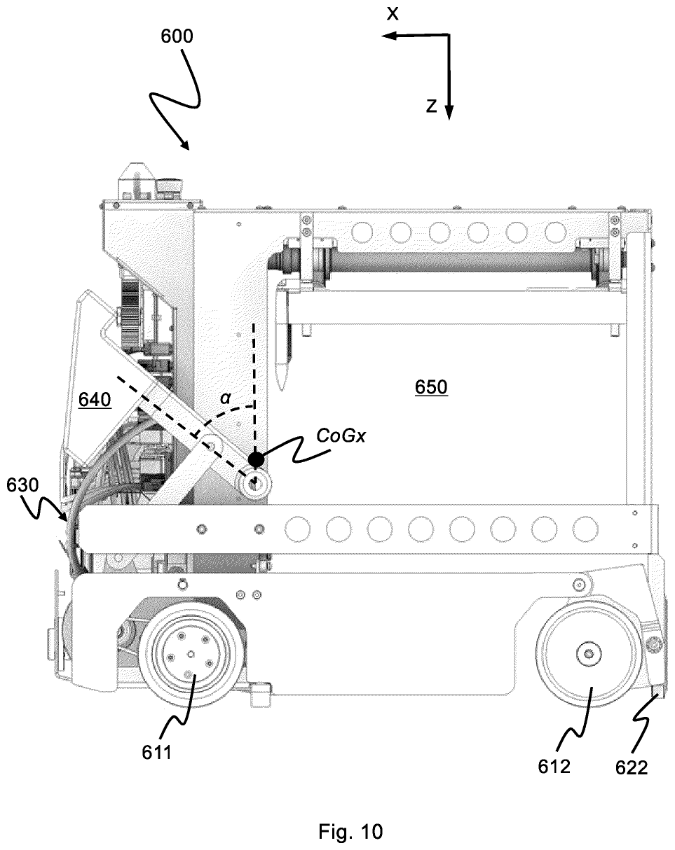

The remotely operated vehicle 600 comprises a counter weight 640. The counter weight 640 is coupled to the wheel lift mechanism 630 such that operation of the wheel lift mechanism 630 causes a centre of gravity CoG of the remotely operated vehicle 600 to change in the first direction X and/or in the second direction Y through movement of the counter weight 640. An example of how the counter weight may be connected to the wheel lift mechanism 630 is shown in FIG. 11, whereas FIG. 8, FIG. 9, and FIG. 10 illustrate operation of the counter weight 640 and how the operation of the counter weight 640 may affect the centre of gravity CoG. In this example the centre of gravity CoG is primarily changed in the first direction X.

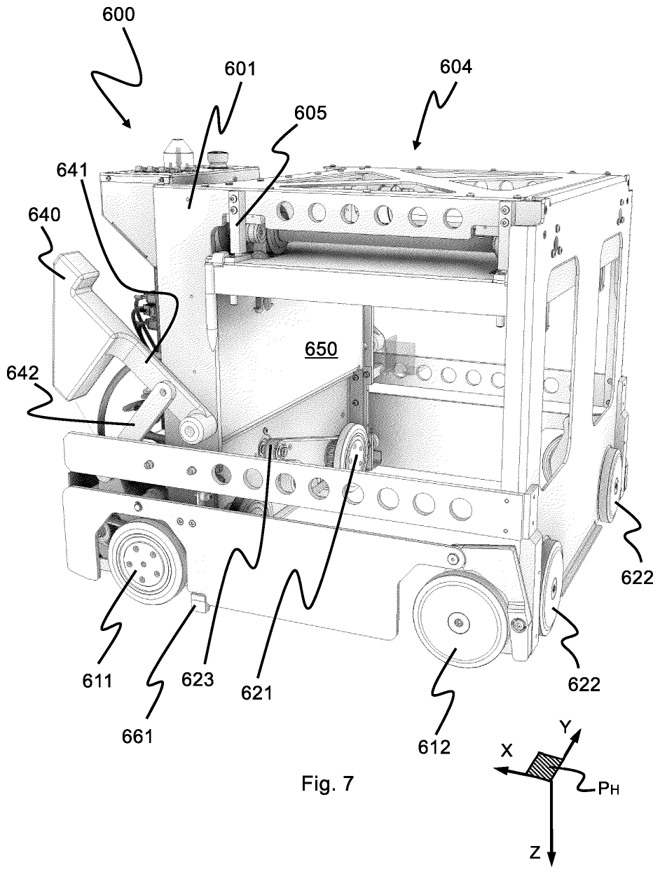

FIG. 7 shows a perspective view of the remotely operated vehicle 600 shown in FIG. 5, wherein some components have been removed. In FIG. 7, three wheels of the first set of wheels 610 and four wheels of the second set of wheels 620 are visible. A fourth wheel of the first set of wheel 610 is visible in FIG. 6.

The first set of wheels 610 may comprise a first pair of drive wheels 611 and a first pair of non-driven wheels 612. The second set of wheels 620 may comprise a second pair of drive wheels 621 and a second pair of non-driven wheels 622.

The remotely operated vehicle may be divided into a first section S1 and a second section S2, as illustrated in FIG. 8. The first pair of drive wheels 611 and the second pair of drive wheels 621 may be arranged in the second section S2. The first pair of non-driven wheels 612 and the second pair of non-driven wheels 622 may be arranged in the first section S1.

When the first set of wheels 610 is engaged with the rail system 108, the weight of the remotely operated vehicle 600 is distributed between the wheels of the first set of wheels 610. If the remotely operated vehicle's 600 centre of gravity CoG is located at the same distance from each wheel of the set of wheels engaged with the rail system 108, then the weight will be evenly distributed between these wheels. However, the weight may not necessarily be evenly distributed between the wheels. Since the distribution of weight between the engaged wheels corelates with a distribution of traction between the engaged wheels, in terms of traction it is preferred to have the centre of gravity in a position where the weight is distributed towards the drive wheels 611, 621 rather than the non-driven wheels 612, 622.

By placing a majority of components in the second section S2, the centre of gravity CoG may be located closer to the drive wheels 611, 621 than the non-driven wheels 621, 622. However, to avoid the remotely operated vehicle 600 from tipping over, some of the weight should be distributed to the non-driven wheels 612, 622 arranged in the first section S1.

If the remotely operated vehicle has a set of wheels in which all wheels are driven, the preferred position of the centre of gravity CoG in terms of traction will typically be at the same distance from each wheel of the set of wheels engaged with the rail system 108.

The first section S1 and the second section S2 may be configured in a similar manner as disclosed in WO2019/206488A1.

The first section S1 having a first section footprint and the second section S2 may have a second section footprint, these footprints being defined by horizontal peripheries in the first direction X and the second direction Y of the first section S1 and the second section S2, respectively.

The remotely operated vehicle 600 may have a vehicle body 601. The vehicle body 601 may have a vehicle body footprint defined by horizontal peripheries in the first direction X and the second direction Y of the vehicle body 601. The vehicle body 601 may comprise a frame and the wheel lift mechanism 630.

The first section S1 and the second section S2 may be arranged side-by-side.

A centre point of the first section S1 footprint may be arranged off centre relative a centre point of the vehicle body footprint.

The first section S1 and the second section S2 may together constitute the entire remotely operated vehicle 600. Alternatively, the remotely operated vehicle 600 may comprise further sections in addition to the first section S1 and the second section S2.

The remotely operated vehicle 600 may be divided into the first section S1 and the second section S2 by a vertical plane Pv extending through the remotely operated vehicle 600, e.g. in the second direction Y. The vertical plane Pv may be a virtual plane that a majority (but not necessarily all) of the internal structure may align with.

The first section S1 and the second section S2 does not need to be physically separated, however there may be at least a partial boundary between them, e.g. a plate. The wheels of the second pair of drive wheels 621, while located in the first section S1, may be mounted on a structure that extends into a recess of a wall (e.g. at least partly formed by the plate) that notionally defines the vertical plane Pv.

The first section S1 and the second section S2 may have different sizes. Their sizes may e.g. be set by one or more components of the remotely operated vehicle 600. As an example, the first section footprint may correspond to the size of a goods holder storage space 650. As another example, the second section footprint may correspond to the size of a compartment configured to accommodate components of the remotely operated vehicle 600.

A size ratio of the first section footprint relative the second section footprint may be at least 2:1. Preferably, the size ratio of the first section footprint relative the second section footprint may be 3:1, even more preferably the size ratio of the first section footprint relative the second section footprint may be 4:1.

The combined horizontal extent of the first section footprint and the second section footprint in the first direction X may correspond to the horizontal extent of the vehicle body in the first direction X.

The second section footprint and the vehicle body footprint may have corresponding horizontal extents in the second direction Y. The first section footprint and the vehicle body footprint may have corresponding horizontal extents in the second direction Y. The first section footprint and the second section footprint may have corresponding horizontal extents in the second direction Y.

The first set of wheels 610 may comprise four wheels. The wheels of the first set of wheels 610 may be arranged on opposite sides of the remotely operated vehicle 600.

The wheels of the first pair of non-driven wheels 612 may be arranged on opposite sides of the first section S1.

The wheels of the first pair of drive wheels 611 may be arranged on opposite sides of the second section S2. Preferably none of said opposite sides are the side of the second section S2 being adjacent the first section S1. E.g. if the second section S2 has four sides, with a second side marking a transition from the second section S2 to the first section S1, the wheels of the first pair of drive wheels 611 may be arranged on a first side and a third side. The wheels of the second pair of drive wheels 621 may be arranged next to the second side; for example, the second pair of drive wheels 621 may be arranged on a support which is configured to recess the second pair of drive wheels 621 into a region of the second section S2 while facing into the first section S1.

The second set of wheels 620 may comprise four wheels. The wheels of the second set of wheels 620 may be arranged on opposite sides of the first section S1.

The wheels of the second pair of non-driven wheels 622 may be arranged on the same side of the first section S1.

The wheels of the second pair of drive wheels 621 may be arranged on the same side of the first section S1.

The wheels of the second pair of drive wheels 621 may be arranged on the side of the first section S1 being closest to the second section S2.

The second pair of non-driven wheels 622 and the second pair of drive wheels 621 may be arranged on opposite sides of the first section S1.

The wheels of the first set of wheels 610 and the wheels of the second set of wheels 620 are preferably not arranged on the same side of the first section S1. E.g. if the first section has four sides, the first set of wheels 610 may be arranged on a first side and a third side, while the second set of wheels 620 may be arranged on a second side and a fourth side.

The first section S1 may have four corners. At least some of the wheels may then preferably be arranged in the corners without extending beyond the first section footprint.

The second section S2 may have four corners. At least some of the wheels may then preferably be arranged in the corners without extending beyond the second section footprint.

The first sets of wheels 610 and/or the second set of wheels 620 may be arranged at or within a lateral extent of the vehicle body 601.

The footprint of the first section S1 may correspond to a grid cell 130 of the rail system 108, and, during use, when the remotely operated vehicle 600 is in a position to lift or lower a goods holder, the second section S2 may be horizontally displaced relative the grid cell 130 and extend partly into a neighbouring grid cell 130.

For a rail system with rails with double tracks in both the first direction X and the second direction Y, a grid cell 130 is defined as the cross-sectional area, including width of the rails 110, 111, between the midpoint of two rails 110 running in the X direction and the midpoint of two rails 111 running in the Y direction.

An extent of the vehicle body footprint in the first direction, LX, and in the second direction, LY, may be:
LX=1.0 grid cell in the X direction, and
1<LY<1.5 grid cells in the Y direction.

The second section S2 may extend less than 50% into the neighbouring grid opening 112, more preferably less than 40% into the neighbouring grid opening 112, even more preferably less than 30% into the neighbouring grid opening 112.

A grid opening 112 may be defined as the open cross-sectional area between two opposed rails 110 running in the X direction and two opposed rails 111 running in the Y direction.

The first pair of non-driven wheels 612, the second pair for non-driven wheels 622 and the second pair of drive wheels 621 may be arranged to define a rectangle in a horizontal plane, wherein the first pair of drive wheels 611 are arranged outside said rectangle.

FIG. 8 shows a side view of the remotely operated vehicle 600. The remotely operated vehicle 600 may comprise: a first set of wheels 610 configured to move the remotely operated vehicle 600 in the first direction X along a first set of rails 110; a second set of wheels 620 configured to move the remotely operated vehicle 600 in the second direction Y along the second set of rails 111; a wheel lift mechanism 630 configured to disengage the first set of wheels 610 from the rail system 108 to bring the second set of wheels 620 into engagement with the second set of parallel rails 111, and configured to disengage the second set of wheels 620 from the rail system 108 to bring the first set of wheels 610 into engagement with the first set of parallel rails 110; and a counter weight 640 coupled to the wheel lift mechanism 630 such that operation of the wheel lift mechanism 630 causes a centre of gravity CoG of the remotely operated vehicle 600 to change in the first direction X and/or in the second direction Y through movement of the counter weight 640. In the example of FIGS. 8-10, the centre of gravity CoG changes in the first direction X.

In FIG. 8 the counter weight 640 is connected to the vehicle body 601 by means of a first arm 641. The first arm 641 is linked to the counter weight 640 at a first end and pivotally connected to the vehicle body 601 at a second end. The counter weight 640 is coupled to the wheel lift mechanism 630 by means of a second arm 642. The second linkage 642 is connected to the wheel lift mechanism 630 at a first end and pivotally connected to a middle portion of the first linkage 641 at a second end. Operation of the wheel lift mechanism 630 thus causes the first linkage 641 to pivot which in turn moves the counter weight 640 in the first direction X.

In FIG. 8, the first set of wheels 610 are lifted by means of the wheel lift mechanism 630 such that the second set of wheels 620 can be engaged with the rail system 108. The counter weight 640 is in a position which can be referred to as an initial position, directly above the point at which the first linkage 641 is connected to the vehicle body 601. The first linkage 641 is vertically oriented, i.e. with its longitudinal direction parallel to the third direction Z.

FIG. 8 illustrates an approximate position of the centre of gravity CoGy for the remotely operated vehicle 600 when set up to move in the second direction Y. The centre of gravity CoGy is closer to the second pair of drive wheels 621 than the second pair of non-driven wheels 622. The counter weight 640 is also closer to the second pair of drive wheels 621 than the second pair of non-driven wheels 622. If the counter weight 640 was removed from the remotely operated vehicle 600, the centre of gravity CoGy would shift to a position further away from the second pair of drive wheels 621. As such, the counter weight 640 is configured to move the centre of gravity CoG towards the second pair of drive wheels 621, such that the weight of the remotely operated vehicle 600 is distributed to the second pair of drive wheels 621 by at least 60%, preferably at least 70%, more preferred at least 80%, and even more preferred at least 90% when the remotely operated vehicle 600 is stationary and not handling a goods holder. To prevent the remotely operated vehicle 600 tipping over, the weight of the remotely operated vehicle 600 should preferably be distributed to the second pair of drive wheels 621 by less than 100%.

In its initial position, the counter weight 640 may be partly located in the first section S1 and partly located in the second position S2.

In FIG. 8, the point at which the first linkage 641 is pivotally connected to the vehicle body 601 is located in the vertical plane Pv separating the first section S1 and the second section S2.

In the initial position of the counter weight 640, the point at which the second linkage 642 is pivotally connected to the first linkage 641 is located in the vertical plane Pv separating the first section S1 and the second section S2.

FIG. 9 shows a side view of the remotely operated vehicle 600 of FIG. 8, wherein the wheel lift mechanism 630 has been operated to partly lower the first set of wheels 610. Operation of the wheel lift mechanism 630 causes movement of the second linkage 642, which in turn pulls the first linkage 641 such that it is rotated (counter clockwise in FIG. 9), which in turn causes the position of the counter weight 640 to change in the first direction X (to the left in FIG. 9).

Compared to the situation in FIG. 8, the counter weight 640 has been moved further away from the first pair of non-driven wheels 612 and the second pair of non-driven wheels 622 in FIG. 9. Compared to the situation in FIG. 8, the centre of gravity CoG has also been moved further away from the first pair of non-driven wheels 612 and the second pair of non-driven wheels 622 in FIG. 9.

In FIG. 9, the counter weight 640 is located in the second position S2.

In FIG. 9, the point at which the first linkage 641 is pivotally connected to the vehicle body 601 is located in the vertical plane Pv separating the first section S1 and the second section S2.

In FIG. 9, the point at which the second linkage 642 is pivotally connected to the first linkage 641 is located in the second section S2.

FIG. 10 shows a side view of the remotely operated vehicle 600 of FIG. 8, wherein the wheel lift mechanism 630 has been operated to fully lower the first set of wheels 610 such that the first set of wheels 610 can be engaged with the rail system 108. The further operation of the wheel lift mechanism 630 causes further movement of the counter weight 640. The first linkage 641 has rotated an angle α relative to the initial position of FIG. 8.

FIG. 10 illustrates an approximate position of the centre of gravity CoGx for the remotely operated vehicle 600 when set up to move in the first direction X. The centre of gravity CoGx is closer to the first pair of drive wheels 611 than the first pair of non-driven wheels 612. The counter weight 640 is also closer to the first pair of drive wheels 611 than the first pair of non-driven wheels 612, and located on the opposite side of the first pair of drive wheels 611 as the non-driven wheels 612.

As compared to the centre of gravity CoGy for the remotely operated vehicle 600 when set up to move in the second direction Y, the centre of gravity CoGx for the remotely operated vehicle 600 when set up to move in the firsts direction X is closer to the first pair of drive wheels 611. The centre of gravity CoGx may be directly above the second pair of drive wheels 621 or on the opposite side of the second drive wheels 621 as the second non-driven wheels 622 since the weight of the remotely operated vehicle 600 is no longer carried by the second set of wheels 620. As such, the counter weight 640 is configured to move the centre of gravity CoG towards the first pair of drive wheels 611, such that the weight of the remotely operated vehicle 600 is distributed to the first pair of drive wheels 611 by at least 60%, preferably at least 70%, more preferred at least 80%, and even more preferred at least 90% when the remotely operated vehicle 600 is stationary and not handling a goods holder. To prevent the remotely operated vehicle 600 tipping over, the weight of the remotely operated vehicle 600 should preferably be distributed to the first pair of drive wheels 611 by less than 100%.

In FIG. 10, the counter weight 640 is located in the second position S2.

In FIG. 10, the point at which the first linkage 641 is pivotally connected to the vehicle body 601 is located in the vertical plane Pv separating the first section S1 and the second section S2. This point may thus be stationary as the counter weight 640 change its position.

In FIG. 10, the point at which the second linkage 642 is pivotally connected to the first linkage 641 is located in the second section S2.

FIG. 11 shows a perspective view of the remotely operated vehicle 600 of FIGS. 6-10 wherein further components have been removed.

FIG. 11 shows the lifting device 604 in an upper position above a goods holder storage space 650. The lifting device 604 may comprise: a lifting band 604a, a gripper 604b, guide pin 604c, a lifting frame 604d, and a lifting device motor 604e. In the configuration of FIG. 11, a lifting band 604a, a gripper 604b, guide pin 604c, a lifting frame 604d are arranged in the first section SI, and the lifting device motor 604e is arranged in the second section S2.

The lifting device motor 604e is configured to raise and lower the lifting frame 604d by means of the lifting bands 604a connected to the top of the lifting frame 604d. The lifting frame 604d may thus be lowered into a storage column 105 to retrieve a goods holder. The gripper 604b is configured to latch onto a goods holder. The guide pin 604c is configured to ensure correct alignment between the lifting frame 604d and the goods holder. When latched onto a goods holder, the lifting device 604 can be raised into the goods holder storage space 650 while carrying the goods holder, such that the goods holder can be stowed in the goods holder storage space 650.

In the configuration of FIG. 11, the goods holder storage space 650 is arranged in the first section S1. A goods holder stowed in the goods holder storage space 650 will thus also be arranged in the first section S1.

The upper position of the lifting frame 604d may be determined by one or several stop(s) 605 providing an end stop for the raising of the lifting frame 604d. The stops 605 may be arranged on the vehicle body 601 and have a height H. The stopping position of the lifting frame 604d may be provided by a lower end of the stop 605 at which the lifting frame 604d can come into contact when raised. The height H of the stop(s) 605, i.e. their vertical extent, will determine the stopping position. By providing interchangeable stops 605 of different heights, the upper position of the lifting frame 604d can thus be adjusted. The upper position may typically be adjusted if the remotely operated vehicle 600 is due to handle goods holders of a different height. The upper position can then be kept as low as possible in order to also keep the centre of gravity CoG as low as possible.

FIG. 11 also shows how the remotely operated vehicle 600 may comprise two counter weights 640. It is also illustrated how one or two counter weights 640 may be coupled to the wheel lift mechanism 630 via respective first linkage 641 and second linkage 642. The wheel lift mechanism 630 may comprise a drive wheel bracket 633 to which the second linkage 642 can be pivotably connected.

FIG. 12 shows a perspective view of the remotely operated vehicle 600 of FIG. 11 wherein further components have been removed. FIG. 12 illustrates an example of a wheel lift mechanism 630 comprising: a wheel lift motor 631, a wheel lift linkage 632, a drive wheel bracket 633, a wheel lift linkage plate 634, a non-driven wheel bracket 635, an drive wheel axle 636, and a spacer 637.

The wheel lift motor 631 may be connected to the vehicle body 601 and arranged in the second section S2. The wheel lift linkage 632 may be pivotally connected to the wheel lift motor 631 at a first end and pivotally connected to the drive wheel bracket 633 at a second end. Torque from the wheel lift motor 631 cause a reciprocating motion of the wheel lift linkage 632. The reciprocating motion of the wheel lift linkage 632 displaces the drive wheel bracket 633 downwards.

The drive wheel bracket 633 may be configured to suspend a drive wheel 611 or a drive wheel axle 636. There will typically be two drive wheel brackets 633 arranged on opposite sides of the second section S2. By being connected, e.g. by the drive wheel axle 636, the two drive wheel brackets 633 will move together in response to the reciprocating motion of the wheel lift linkage 632. As such, the first pair of drive wheels 611 suspended by the drive wheel brackets 633 can be lowered and raised in response to operation of the wheel lift motor 631.

The drive wheel brackets 633 may be configured to hold a motor 613 for the first pair of drive wheels 611 and an associated motor shaft 614.

There will typically be two non-driven wheel brackets 635 arranged on opposite sides of the first section SI. The non-driven wheel brackets 635 may be pivotally connected to the vehicle body 601 and configured to suspend the first pair of non-driven wheels 612.

A drive wheel bracket 633 and a non-driven wheel bracket 635 arranged on the same side of the remotely operated vehicle 600 may be connected by the wheel lift linkage plate 634. Lowering and raising the first pair of drive wheels 611 will then also cause the first pair of non-driven wheels 612 to be lowered and raised. The drive wheel bracket 633 and the non-driven wheel bracket 635 may be connected at a distance from the wheel lift linkage plate 634, e.g. by means of a spacer 637.

FIG. 13 and FIG. 14 show perspective views of the remotely operated vehicle 600 of FIG. 5 wherein some components have been removed. In FIG. 13, the wheel lift mechanism 630 has raised the first set of wheels 610 and in FIG. 14, the wheel lift mechanism 630 has lowered the first set of wheels 610. The full stroke of the wheel lift linkage 632 may be achieved by half a turn of the wheel lift motor 631.

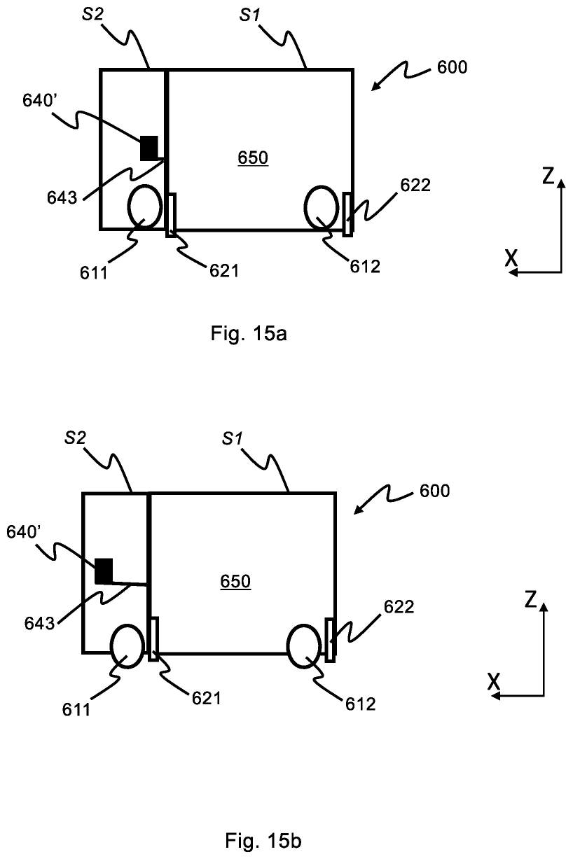

FIG. 15a and FIG. 15b show schematically how a counter weight 640′ may be moved by means of an actuator 643. In FIG. 15a, the second set of wheels 620 are engageable with the rail system 108. The counter weight 640′ is then in an initial position where it affects the centre of gravity CoG in an advantageous manner for movement of the remotely operated vehicle 600 in the second direction Y. Whereas in FIG. 15b, the first set of wheels 610 are engageable with the rail system 108. The counter weight 640′ is then in a subsequent position where it affects the centre of gravity CoG in an advantageous manner for movement of the remotely operated vehicle 600 in the first direction X.

When the control system 500 sends a signal to the wheel lift mechanism 630 instructing the wheel lift mechanism 630 to lower the first set of wheels 610, a signal may simultaneously (or shortly before/after) be sent to the actuator 643 instructing the actuator 643 to move the counter weight 640′ from its initial position to its subsequent position.

When the control system 500 sends a signal to the wheel lift mechanism 630 instructing the wheel lift mechanism 630 to raise the first set of wheels 610, a signal may simultaneously (or shortly before/after) be sent to the actuator 643 instructing the actuator 643 to move the counter weight 640′ from its subsequent position to its initial position.

The initial position and the subsequent position of the counter weight 640′ may have the same vertical elevation.

The counter weight 640′, 640″ may be held by the actuator. Alternatively, the counter weight 640′, 640″ may be movable along a support, e.g. by means of a sliding or rolling interface.

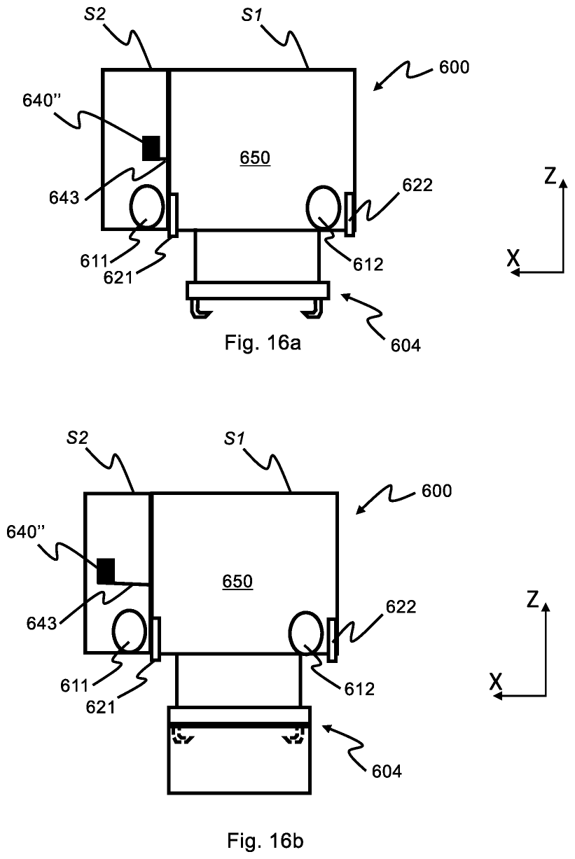

FIG. 16a and FIG. 16b show schematically how a counter weight 640″ may be moved by means of an actuator 643. In FIG. 16a, the remotely operated vehicle 600 is not carrying a goods holder. The counter weight 640″ is then in an initial position where it affects the centre of gravity CoG in an advantageous manner for movement of the remotely operated vehicle 600 without the additional weight of a goods holder and the items stored therein, if any. Whereas in FIG. 16b, the remotely operated vehicle 600 is carrying a goods holder. The counter weight 640″ is then in a subsequent position where it affects the centre of gravity CoG in an advantageous manner for movement of the remotely operated vehicle 600 with the additional weight of the a goods holder and the items stored therein, if any.

When the control system 500 sends a signal to the lifting device 604 instructing the lifting device 604 to latch onto a goods holder, a signal may simultaneously (or shortly before/after) be sent to the actuator 643 instructing the actuator 643 to move the counter weight 640″ from its initial position to its subsequent position.

When the control system 500 sends a signal to the lifting device 604 instructing the lifting device 604 to unlatch from a goods holder, a signal may simultaneously (or shortly before/after) be sent to the actuator 643 instructing the actuator 643 to move the counter weight 640″ from its subsequent position to its initial position.

The first initial position and the subsequent position of the counter weight 640″ may have the same vertical elevation.

The counter weight 640′ of FIGS. 15a-b may be used in combination with the counter weight 640″ of FIGS. 16a-b.

Alternatively, the actuator 643 may be configured to move the counter weight 640′, 640″ a given horizontal distance in response to the lifting device 604 latching/unlatching a goods holder, and a given horizontal distance in response to operation of the wheel lift mechanism 630. The counter weight 640′, 640″ may then have different given positions for the following four scenarios:
a) the remotely operated vehicle 600 does not carry a goods holder while the first set of wheels 610 are engaged with the rail system 108,
b) the remotely operated vehicle 600 does not carry a goods holder while the second set of wheels 620 are engaged with the rail system 108,
c) the remotely operated vehicle 600 does carry a goods holder while the first set of wheels 610 are engaged with the rail system 108, and
d) the remotely operated vehicle 600 does carry a goods holder while the second set of wheels 620 are engaged with the rail system 108.

The lifting device 604 may be provided with load cells configured to measure a weight of a goods holder and its content, if any. Based on the measured weight, a control system 500 may calculate an appropriate position of the counter weight 640, 640′, 640″ (also taking into account if the first set of wheels 610 are engaged or the second set of wheels 620 are engaged) and send a signal to the actuator 643 instructing the actuator 643 to move the counter weight 640, 640′, 640″ to the appropriate position. The CoG will then shift to improve the operational conditions of the remotely operated vehicle 600.

The actuator 643 may typically be an electric actuator.

The actuator 643 may be a linear actuator as shown in FIGS. 15a-16b, alternatively the actuator 643 may be a rotary actuator.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
111 Parallel rails in second direction (Y)
112 Access opening/grid opening 112
119 First port column
120 Second port column
130 Grid cell
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
600 Remotely operated vehicle
601 Body
602 Battery
604 Lifting device
604a Lifting band
604b Gripper
604c Guide pin
604d Lifting frame
604e Lifting device motor
605 Stop
606 Cover plate
610 First set of wheels
611 First pair of drive wheels
612 First pair of non-driven wheels
613 Motor for first pair of drive wheels
614 Motor shaft
620 Second set of wheels
621 Second pair of drive wheels
622 Second pair of non-driven wheels
623 Motor for second pair of drive wheels
630 Wheel lift mechanism
631 Wheel lift motor
632 Wheel lift linkage
633 Drive wheel bracket
634 Wheel lift linkage plate
635 Non-driven wheel bracket
636 Drive wheel axle
637 Spacer
640, 640′, 640″ Counter weight
641 First linkage
642 Second linkage
643 Actuator for counter weight
650 Goods holder storage space
660 Control system
661 Track sensor
662 Stop sensor
X First direction
Y Second direction
Z Third direction
CoG Centre of gravity
CoGx Centre of gravity adapted for movement of the remotely operated vehicle in the first direction X
CoGy Centre of gravity adapted for movement of the remotely operated vehicle in the second direction Y
S1 First section of the remotely operated vehicle
S2 Second section of the remotely operated vehicle
α Angle of rotation
LX Extent of the vehicle body footprint in the first direction X
LY Extent of the vehicle body footprint in the second direction Y
H Height of stop
Pv Vertical plane
PH Horizontal plane

1.-17. (canceled)

18. A remotely operated vehicle for an automated storage and retrieval system, wherein the automated storage and retrieval system comprises a rail system comprising a first set of parallel rails arranged in a horizontal plane and extending in a first direction and a second set of parallel rails arranged in the horizontal plane and extending in a second direction perpendicular to the first direction,
wherein the remotely operated vehicle comprises:
a first set of wheels configured to move the remotely operated vehicle in the first direction along the first set of parallel rails,
a second set of wheels configured to move the remotely operated vehicle in the second direction along the second set of parallel rails,
a wheel lift mechanism configured to disengage the first set of wheels from the rail system to bring the second set of wheels into engagement with the second set of parallel rails, and configured to disengage the second set of wheels from the rail system to bring the first set of wheels into engagement with the first set of parallel rails, and
a counter weight coupled to the wheel lift mechanism such that operation of the wheel lift mechanism causes a centre of gravity of the remotely operated vehicle to change in the first direction and/or in the second direction through movement of the counter weight.

19. The remotely operated vehicle according to claim 18, wherein the first set of wheels comprises a first pair of drive wheels and a first pair of non-driven wheels, and
wherein, when the wheel lift mechanism is operated to engage the first set of wheels with the rail system, the counter weight is configured to move the centre of gravity towards the first pair of drive wheels such that weight of the remotely operated vehicle is distributed to the first pair of drive wheels by at least 60%, 70%, 80%, or 90% when the remotely operated vehicle is stationary and not handling a goods holder.

20. The remotely operated vehicle according to claim 19, wherein wheels of the first pair of drive wheels are axially aligned with each other, and/or wherein wheels of the first pair of non-driven wheels are axially aligned with each other.

21. The remotely operated vehicle according to claim 18, wherein the second set of wheels comprises a second pair of drive wheels and a second pair of non-driven wheels, and
wherein, when the wheel lift mechanism is operated to engage the second set of wheels with the rail system, the counter weight is configured to move the centre of gravity (CoGy) towards the second pair of drive wheels, such that weight of the remotely operated vehicle is distributed to the second pair of drive wheels by at least 60%, 70%, 80%, or 90% when the remotely operated vehicle is stationary and not handling a goods holder.

22. The remotely operated vehicle according to claim 21,
wherein wheels of the second pair of drive wheels are aligned in a common vertical plane, and/or
wherein wheels of the second pair of non-driven wheels are aligned in a common vertical plane.

23. The remotely operated vehicle according to claim 18, wherein the remotely operated vehicle comprises:
a vehicle body,
a first linkage linked to the counter weight at a first end and pivotally connected to the vehicle body at a second end, and
a second linkage connected to the wheel lift mechanism at a first end and a pivot connection to a middle portion of the first linkage at a second end, such that operation of the wheel lift mechanism causes the first linkage to pivot.

24. The remotely operated vehicle according to claim 23, wherein the counter weight has an initial position in which it is vertically aligned with the pivot connection at the second end of the first linkage.

25. The remotely operated vehicle according to claim 24, wherein operation of the wheel lift mechanism causes an angular displacement of the first linkage of at least 15°, 30°, or 45°.

26. The remotely operated vehicle according to claim 18, wherein the remotely operated vehicle is configured to handle a goods holder.

27. The remotely operated vehicle according to claim 18, wherein the remotely operated vehicle comprises a goods holder storage space.

28. The remotely operated vehicle according to claim 27, wherein the remotely operated vehicle comprises a first section and a second section adjacent the first section, wherein the goods holder storage space is arranged in the first section.

29. The remotely operated vehicle according to claim 28, wherein the counter weight is arranged to be moved from a position within the second section to a position at least partly within the first section.

30. The remotely operated vehicle according to claim 28, wherein the wheel lift mechanism is partly arranged in the second section.

31. The remotely operated vehicle according to claim 28, wherein the first pair of drive wheels is in the second section.

32. The remotely operated vehicle according to claim 28, wherein the first pair of non-driven wheels and/or the second pair of non-driven wheels and/or the second pair of drive wheels are in the first section.

33. An automated storage and retrieval system comprising:
at least one remotely operated vehicle as recited in claim 18;
a framework structure for storing goods holders, the framework structure including a rail system, on which the remotely operated vehicle can move, arranged on top of the framework structure and comprising a first set of parallel rails arranged in a horizontal plane and extending in a first direction and a second set of parallel rails arranged in the horizontal plane and extending in a second direction perpendicular to the first direction; and
a plurality of goods holders.

34. A method of operating an automated storage and retrieval system, the method comprising:
using with an automated storage and retrieval system as recited in claim 33:
operating the wheel lift mechanism to engage the first set of wheels with the rail system,
moving the counter weight to adjust a centre of gravity for movement of the remotely operated vehicle in the first direction,
moving the remotely operated vehicle a predetermined distance in the first direction,
operating the wheel lift mechanism of the remotely operated vehicle to disengage the first set of wheels from the rail system and to engage the second set of wheels with the rail system,
moving the counter weight to adjust a centre of gravity for movement of the remotely operated vehicle in the second direction, and
moving the remotely operated vehicle a predetermined distance in the second direction.

35. The method according to claim 34, wherein the remotely operated vehicle is configured to handle a goods holder.

36. The method to claim 34, wherein the remotely operated vehicle comprises a goods holder storage space.

37. The method according to claim 36, wherein the remotely operated vehicle comprises a first section and a second section adjacent the first section, wherein the goods holder storage space is arranged in the first section.
